(19) United States
(12) Patent Application Publication
(10) Pub. No.: US 2005/0221251 A1
(43) Pub. Date: Oct. 6, 2005

(54) Method and device for improving oral health

(76) Inventors: Nikos S. Soukos, Boston, MA (US); Max Goodson, Boston, MA (US); Gordon Row, Lexington, MA (US); John Warner, Warner, NH (US); R. Eric Montgomery, Lee, MA (US)

Correspondence Address: MAYER, BROWN, ROWE & MAW LLP, P.O. BOX 2828, CHICAGO, IL, 60690-2828, US

(21) Appl. No.: 11/044,531

(22) Filed: Jan. 26, 2005

Related U.S. Application Data
(63) Continuation-in-part of application No. 10/895,694, filed on Jul. 21, 2004.
(60) Provisional application No. 60/488,778, filed on Jul. 21, 2003.

(51) Int. Cl. A61C 3/00; A61C 5/00

(52) U.S. Cl. 433/29; 433/215

(57) ABSTRACT

The present invention relates to a method for improving the oral health of a subject by exposing the oral cavity of the subject to a device comprising a light source that emits a therapeutically effective amount of light. The present invention further relates to devices utilized in exposing light to the oral cavity of a subject in the method of the present invention.

### RELATED CASES

This application is a continuation-in-part to and claims priority to U.S. application Ser. No. 10/895,694, filed Jul. 21, 2004, and U.S. Provisional Application Ser. No. 60/488,778, filed Jul. 21, 2003, which are incorporated herein by reference in their entirety to the extent permitted by law.

### FIELD OF THE INVENTION

The present invention relates to methods and devices for improving the health of the oral cavity of a subject.

### BACKGROUND OF THE INVENTION

Periodontal (gum) diseases affect 80 to 90% of adults and are a major cause of tooth loss in the Western world now that caries (tooth decay) incidence is in decline. They occur with increased frequency in patients with Down's syndrome and with systemic diseases such as diabetes mellitus, AIDS, leukemia, neutropenia, and Crohn's disease. Many bacteria live in the oral cavity. Some investigators have suggested that as many as 600 species may be identified. The panel of organisms living in the oral cavity include, but are not limited to, periodontal pathogens (P. gingivalis, T. forsythensis, T. denticola, and A. actinomycetemcomitans), bacteria thought to be pre-pathogenic (e.g., P. nigrescens, F. periodonticum and other Fusobacterium, C. rectus, Eubacterium sp., P. micros, E. corrodens, and Selenomonas noxia), bacteria thought to be beneficial (e.g., A. naeslundii and other Actinomycetes, S. sanguis and other Streptoccocci) and bacteria principally associated with gingivitis (e.g., V. parvula). The Gram negative, black-pigmenting anaerobes of the genera Prevotella and Porphyromonas are important pathogens associated with these conditions. Porphyromonas gingivalis is a Gram-negative black-pigmenting anaerobe that is most strongly associated with progressive periodontal (gum) disease in adults. The standard battery of 40 periodontal bacteria are included in Table 1.

TABLE 1

| | | |
|---|---|---|
| Actinomyces naeslundii 1 | Streptococcus anginosus | Neisseria mucosa |
| Streptococcus constellatus | Streptococcus sanguis | Fusobacterium nucleatum ss |
| | | nucleatum |
| Eubacterium nodatum | Actinomyces gerencseriae | Capnocytophaga gingivalis |
| Porphyromonas gingivalis | Streptococcus oralis | Streptococcus gordonii |
| Actinobacillus | Capnocytophaga ochracea | Taneralla forsythensis |
| actinomycetemcomitans | | |
| (serotypes a & b) | | |
| Fusobacterium nucleatum ss | Actinomyces israelii | Selenomonas noxia |
| vincentii | | |
| Campylobacter rectus | Streptococcus intermedius | Propionibacterium acnes |
| | | (serotypes I & II) |
| Treponema socranskii | Treponema denticola | Prevotella melanogenica |
| Eubacterium saburreum | Prevotella nigrescens | Streptococcus mitis |
| Peptostreptococcus micros | Actinomyces odontolyticus | Eikenella corrodens |
| | (serotype I) | |
| Veillonella parvula | Fusobacterium nucleatum ss | Gemella morbillorum |
| | polymorphum | |
| Actinomyces naeslundii 2 | Camplylobacter showae | Capnocytophaga sputigena |
| (A. viscosus) | | |
| Campylobacter gracillis | Fusobacterium periodonticum | Leptotrichia buccalis |
| Prevotella intermedia | | |

Conventionally, prevention and control of the periodontal diseases is by home care, which is directed to remove or to modify bacterial plaque. This generally includes tooth brushing, toothpaste, antibacterial mouth rinses, and interperoximal cleaning aids, such as floss, toothpicks, interproximal stimulators and interproximal brushes. When regularly applied, these methods reduce the mass of bacterial plaque. However, these methods do not affect the composition or species distribution of the bacterial plaque. Further, these methods are painful, abrasive, burdensome, and the effects that they produce are often short-lived.

Thus, there is a need for a therapy that affects the composition of the bacterial plaque and reduces their pathogenic potential. There is also a need for a painless, abrasion-free, easy-to-apply periodontal therapy that produces a sustained effect for a longer period of time following a single or multiple in-office or take-home treatments.

### SUMMARY OF THE INVENTION

The present invention provides a method for improving the health of the oral cavity. More particularly, the present invention relates to a method of improving the oral health of a subject by exposing a portion of the oral cavity of the subject to light and optionally an oxidizing or other auxiliary agent to selectively eliminate or reduce bacteria from the oral cavity of a subject. One aspect of the present invention relates to a method of reducing gingivitis in the subject by exposing the oral cavity of the subject to a light source for a predetermined period of time. The present invention further relates to devices utilized in exposing light to the oral cavity of a subject in the method of the present invention. In one aspect, the oral health device includes a light source to be positioned outside the oral cavity during use that is in communication with a light distributor to be positioned inside the oral cavity. In another aspect, the light source is fully self-contained within a device that fits within the oral cavity.

### BRIEF DESCRIPTION OF THE DRAWINGS

FIG. 1 is a side perspective view of a light-emitting device used to improve the overall oral health of a subject.

FIG. 2 is an exploded view of a device of the present invention.

FIG. 2A is an enlarged view of the facet of FIG. 2.

FIG. 3 is a side perspective view of another embodiment of a device of the present invention.

FIG. 4 is a cross section of the light guide along line 4-4 of FIG. 3.

FIG. 5 depicts the optical spectrum from 380-520 nm from one embodiment a high intensity light source.

FIG. 6 is a bar graph depicting the survival rate of selected bacteria after exposure to the light source of FIG. 5.

FIG. 7 is a bar graph depicting the survival rate of all bacteria after exposure to the light source of FIG. 5.

FIG. 8 is a bar graph depicting the growth inhibition rate of black-pigmented bacteria versus other species after exposure to the light source of FIG. 5.

FIG. 9 is a bar graph depicting growth inhibition of each of the 40 species at five minutes of illumination.

FIG. 10 is a bar graph depicting the Gingival Index of the subjects, in each of the four treatment groups, over six months.

FIG. 11 is a bar graph depicting the Plaque Index of the subjects, in each of the four treatment groups, over six months.

FIG. 12 is a bar graph depicting the change in the overall gingival color (ΔE) of the subjects, in each of the four treatment groups, over six months.

FIG. 13 is a bar graph depicting the change in the pocket depth of the subjects, in each of the four treatment groups, over six months.

FIG. 14 is a bar graph depicting the change in the amount of bleeding on probing of the subjects, in each of the four treatment groups, over six months.

FIG. 15 is a bar graph depicting the mean Eastman Dental Bleeding Index (“EDBI”) of the subjects, in each of the four treatment groups, over six months.

FIG. 16 is a bar graph depicting the total number of bacteria per tooth of the subjects, in each of the four treatment groups, over six months.

FIG. 17 is a bar graph depicting the baseline proportions of the 40 bacteria found on the tooth's surface.

FIG. 18 is a bar graph depicting the post-treatment proportions of the 40 bacteria found on the tooth's surface.

FIG. 19 is a bar graph depicting the one-week proportions of the 40 bacteria found on the tooth's surface.

FIG. 20 is a bar graph depicting the one-month proportions of the 40 bacteria found on the tooth's surface.

FIG. 21 is a bar graph depicting the six-month proportions of the 40 bacteria found on the tooth's surface.

FIG. 22 depicts the distribution of the proportions of P. gingivalis from the subjects, of each of the four treatment groups, over all visits.

FIG. 23 is a line graph depicting the proportion of P. gingivalis in the periodontal plaque of the subjects, in each of the four treatment groups, six months after treatment.

FIG. 24 is a bar graph depicting the change in numbers of black-pigmented bacteria after treatment with light and or peroxide versus placebo.

FIG. 25 is a bar graph depicting the growth inhibition ratio of black-pigmented bacteria on biofilms made from periodontal plaque samples after 3 and 4 days of exposure to light.

FIG. 26 is a bar graph depicting the growth inhibition ratio of specific black-pigmented bacteria on biofilms made from periodontal plaque samples after 4 days of exposure to light.

FIG. 27 is a bar graph depicting the clinical measurements at baseline and after 4 days on the sides of the mouth that were both exposed and unexposed to light.

FIG. 28 is a bar graph depicting the total number of bacteria on the sides of the mouth that were exposed to light, versus the sides of the mouth that were unexposed to light, after 4 days.

FIG. 29 is a bar graph depicting the difference in the percentage change of black pigmented bacteria on the sides of the mouth that were exposed to light versus the sides of the mouth that were unexposed to light.

FIG. 30 is a bar graph depicting the reduction in the proportions of P. gingivalis on the surface of the teeth, which had a proportion of P. gingivalis at baseline of less than 1%, following exposure to visible light.

FIG. 31 is a bar graph depicting the reduction in the proportions of P. gingivalis on the surface of the teeth, which had a proportion of P. gingivalis at baseline of greater than 1%, following exposure to visible light.

FIG. 32 is a bar graph depicting the reduction in the proportions of P. intermedia on the surface of the teeth, which had a proportion of P. intermedia at baseline of less than 1%, following exposure to visible light.

FIG. 33 is a bar graph depicting the reduction in the proportions of P. intermedia on the surface of the teeth, which had a proportion of P. intermedia at baseline of greater than 1%, following exposure to visible light.

FIG. 34 is a perspective view of another embodiment of the device of the present invention.

FIG. 35 is a perspective view of another embodiment of the device of the present invention.

FIG. 36 is a perspective view of another embodiment of the device of the present invention.

FIG. 37 is a side perspective view of the light that is emitted from an embodiment of the device of the present invention.

FIG. 38 is a side perspective view of a bidirectional illuminating plate with V-shaped grooves formed at a 160 degree angle.

FIG. 39 is a side perspective view of a bidirectional illuminating plate with V-shaped grooves formed at a 45 degree angle.

FIG. 40 is a side perspective view of a bidirectional illuminating plate.

FIG. 41 is a side perspective view of an embodiment of the device of the present invention delivering light to a subject's or patient's teeth and gums.

FIG. 42 is a side perspective view of an embodiment of the device of the present invention piping light through a subject's or patient's tooth into the gums.

FIG. 43 is a side perspective view of another embodiment of the device of the present invention.

FIG. 44 is a side perspective view of an embodiment of the device of the present invention that only distributes light to the teeth when pressure is exerted on the device.

FIG. 45 is a side perspective view of an embodiment of the device of the present invention illustrating how light is distributed to the teeth when bite pressure is exerted on the device.

FIG. 46 is a side perspective view of an embodiment of the device of the present invention illustrating how light is distributed to the teeth when bite pressure is exerted on the device.

FIG. 47 is a line graph depicting the survival fraction of oral species following irradiation of planktonic cell suspensions.

FIG. 48 is a chromatogram of a mixture of standard porphyrins in the order of decreasing retention time, and HPLC analysis of the porphyrin content of the black-pigmented bacteria.

FIG. 49 is a bar graph depicting the reduction in total counts (CFU) after exposure of pooled dental plaque samples to visible light of 4.2 and 21 J/cm².

FIG. 50 is a bar graph depicting the inhibition of black-pigmented bacteria growth after their exposure to light.

FIG. 51 is a bar graph depicting the suppression of the black-pigmented bacteria growth after their exposure to light.

FIG. 52 is a bar graph depicting the Gingival Index of the subjects over two years.

FIG. 53 is a bar graph depicting the Plaque Index of the subjects over two years.

### DETAILED DESCRIPTION

The present invention relates to the exposure of the oral cavity of a subject to a therapeutically effective amount of light to improve oral health. Alternatively, the oral cavity may be exposed to a therapeutically effective amount of both light and an oxidizing agent to improve oral health. In yet another alternative, the oral cavity may be exposed to a therapeutically effective amount of both light and at least one auxiliary chemical agent that increases the susceptibility of oral bacteria to light. In yet another alternative, the oral cavity may be exposed to a therapeutically effective amount of light while simultaneously being subjected to an auxiliary or therapeutically effective physical or mechanical action. An “effective amount” or “therapeutically effective amount” refers to the amount of light and optional agent or action which is required to confer therapeutic effect on the treated subject.

Several variables relating to the light exposure are important in the present invention: (1) the type of light source used; (2) the intensity/irradiance of the light; (3) the wavelength of the light emitted from the light source; (4) the duration of the exposure of the light to the teeth and gums; and (5) the frequency of application. The variables should be considered collectively. For example, the duration of exposure may be inversely proportional to the intensity of the light emitted.

Light sources that may be utilized in the present invention include, but are not limited to, gas plasma, light emitting diode (“LED”), linear flash lamps, tungsten halogen, metal halide, Xenon short arc, Mercury short arc, Mercury Xenon short arc, Argon plasma arc, Argon short arc lamps, and curing lights. The light energy can also be provided by an array of light emitting diodes or laser diodes of suitable wavelength and sufficient power. The light energy can also be provided by chemiluminescent or electroluminescent means. Other light sources are described in U.S. Pat. No. 6,416,319 and PCT WO 01/26576.

Several different types of devices embodying the light source may be utilized to improve the oral health of a subject in the present invention. The devices may be utilized by dental professionals during in-office procedures, by patients or consumers at home, or in regimens using a combination of in-office and home device use. In one embodiment, the light source applies light from outside the oral cavity to a light distributor located inside the oral cavity. The light source delivers the light to the light distributor through a connector. The light is then efficiently distributed to the intended area in the oral cavity. Maintaining the light source outside of the oral cavity is not necessary, but may be preferable due to safety concerns in placing a power source in the oral cavity.

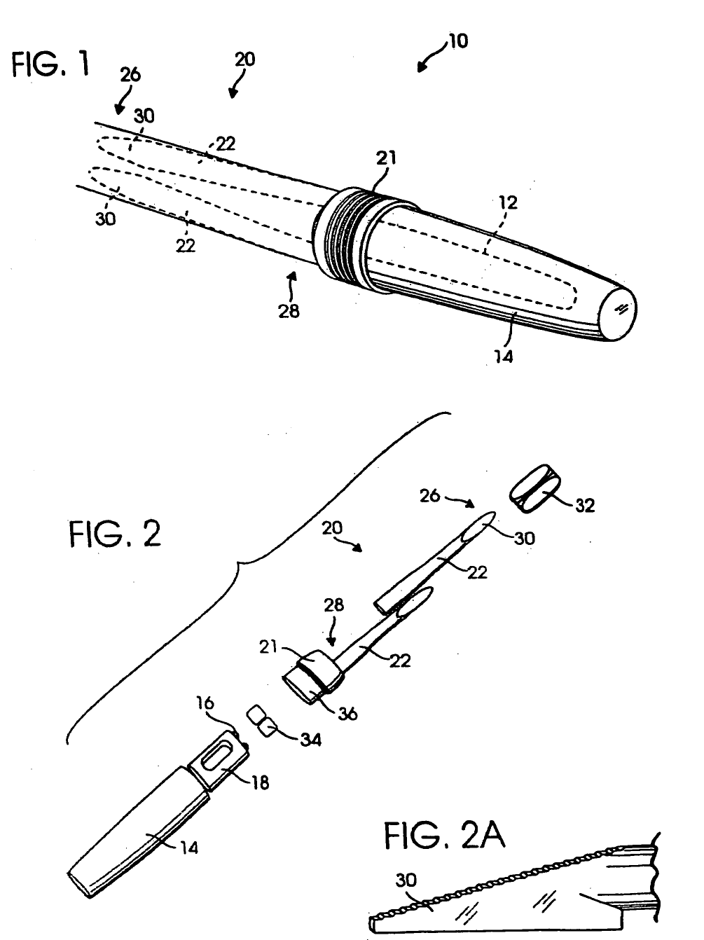

FIGS. 1-2 depict one embodiment of the present invention wherein light is delivered to the oral cavity of a subject by a device 10. The device 10 includes a light source 12 housed within a handle 14 in communication with a light distributor 20. In one embodiment, the light source 12 and light distributor 20 are integrated. In another embodiment, a connector 21 connects the light source 12 to the light distributor 20. A connector 21 may be useful, for example, in a device 10 that has a common handle 14 with interchangeable light sources 12 for multiple users, similar to an electric toothbrush that has interchangeable brushes for a number of users. The light source 12 includes at least one emitter 16 (depicted in FIG. 2 only) for producing the light, and a heat sink 18 for dissipating the heat created from the emitter 16. Preferably, the emitter 16 is designed to be energy efficient so that a substantial portion of the intensity of the light is not converted to heat and may be transferred to the oral cavity. The handle may be manufactured from any type of material that is standard in the art. The other internal components of the light source 12, such as the control circuitry for providing power to the light source 12, are standard in the art and are not shown in the figures. In a preferred embodiment of FIG. 1, the light source 12 is an LED, which has very high optical efficiency.

Light from the light source 12 can be reflected off material either by internal or external reflections. External reflections are reflections where the light originates in a material of low refractive index (such as air) and reflects off of a material with a higher refractive index (such as aluminum or silver). Internal reflections are reflections where the light originates in a material of higher refractive index (such as polycarbonate) and reflects off of a material with lower refractive index (such as air or vacuum or water). A common household mirror operates on external reflection. Fiber optic technology operates on the principle of internal reflections.

Index of refraction is an optic attribute of any material which measures the tendency of light to refract, or bend, when passing through the material. Even materials that do not conduct light (such as aluminum) have indices of refraction.

Typically, external reflections are most efficient when the angle of incidence of the light is near-normal (i.e., light approaches perpendicular to the surface) and degrade as the angle of incidence increases (approaches the surface at a steep angle). Conversely, internal reflections are most efficient at high angles of incidence and fail to reflect at shallow angles. The critical angle is the angle below which light no longer reflects between a pair of materials. In the present invention, either external or internal reflections may be used to tunnel the light to the target area of the oral cavity, and more particularly, the buccal and/or lingual gum tissues.

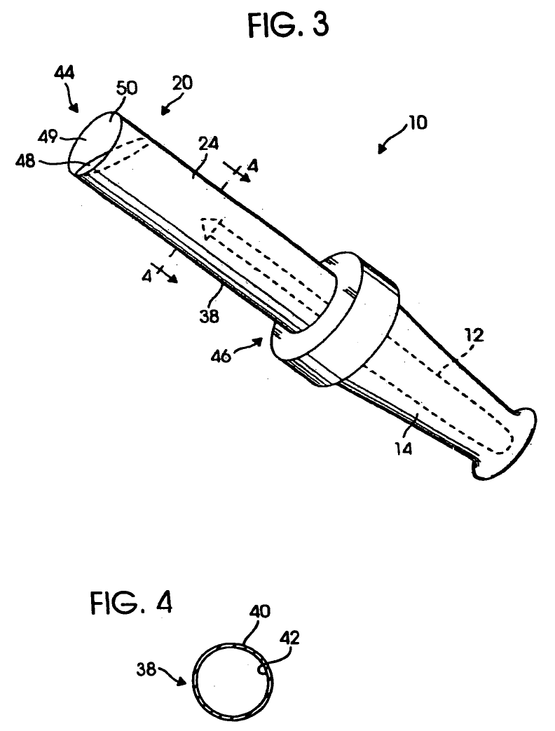

The light distributor 20 may include any component capable of distributing light from a light source 12 to the oral cavity, including but not limited to light pipes (which distribute light through internal reflections) and light guides (which distribute light through external reflections). The light distributor 20 may include one or more of these components, i.e., one or more light pipes or one or more light guides. As the surface area of the oral cavity to be treated increases, for example, the number of light pipes or light guides may also increase. In one embodiment depicted in FIGS. 1-2, the light distributor 20 includes two light pipes 22. In another embodiment, the light distributor 20 includes one light guide 24, shown in FIG. 3, and described below. In all embodiments, the light distributor 20 is preferably suitable for placement within the oral cavity of a subject. The light distributor 20 may be made from any suitable transmitting material with a high index of refraction, such as a polycarbonate, for example. In one embodiment, the light distributor 20 is made from polymethyl methylacrylate (“PMMA”).

In FIGS. 1-2, the two light pipes 22 are symmetrical and each light pipe 22 has a distal end 26 and a proximal end 28. The distal end 26 includes at least one facet 30. Facets 30 are reflecting surfaces that distribute light in a uniform pattern from the light pipe 22. Thus, the light pipe 22 creates a convergent light, which is distributed across a broader field with the use of the facets 30. In FIG. 1, each light pipe includes seven facets 30, four primary facets 30 and three secondary facets 30, for a total of fourteen facets 30. However, any number of facets 30 may be included on the light pipe 22. Both sets of facets 30 reflect light to the distal end 26 of the light pipe 22. Because the light conducted down each light pipe 22 is imperfectly collimated, light can strike the facets 30 over a range of angles (approximately +/−20 degrees). The facets 30 produce internal reflections at an angle close to the critical angle of the material (approximately 41 degrees). Therefore, some oblique light beams may escape from the material. The use of the primary and secondary facets, as in FIG. 1, may prevent the escape and provide an efficient means of achieving near total internal reflection at the turning facets 30. In one embodiment, the primary and secondary facets are angled at about 31 degrees and about 10 degrees, respectively. A bitewing 32 (depicted only in FIG. 2) may be removably attached to the distal end 26 of the light pipe 22 over the facets 30. The bitewing 32 enables the subject to correctly position the facets 30 over the area to be treated to provide efficient distribution of light.

The proximal end 28 of the light pipe 22 engages a collimator 34 (depicted in FIG. 2 only) that focuses scattered light from the emitter 16 and transfers it into the light pipe 22. One type of collimator 34 suitable in the present invention is supplied through Polymer Optics Ltd. (United Kingdom). Other collimators 34 are generally known in the art and suitable for application in the present invention. In one embodiment, the proximal end 28 of the light pipe 22 is integrated with the collimator 34 to prevent surface loss of light transmission. In another embodiment, the proximal end 28 first engages a socket 36 which connects to the collimator 34 (FIG. 2).

In another embodiment of the present invention, depicted in FIG. 3, the light distributor 20 includes at least one light guide 24. The light guide 24 is a hollow tube 38 comprising a thin wall 40 of a highly polished, reflective material 42. The hollow tube 38 may be made from any suitable transmitting material with a high index of refraction, such as a polycarbonate, for example, similar to the other light distributors 20 described above. In one embodiment, the hollow tube 38 is made from PMMA, polycarbonate, acrylic or any other material with a high index of refraction and/or a high degree of transparency or clarity. The light guide 24 has a distal end 44 and a proximal end 46, wherein a highly-polished mirror 48 forms a cap which closes the opening 49 in the light guide 24 near the distal end 44. The distal end 44 of the light guide 24 engages a transparent window 50, which allows the light that is reflected off of the mirror 48 to emit from the hollow tube 38. Facets 30 on the mirror 48 may reflect light off the mirror 48 so that the light strikes the window 50 at a steep enough angle to exit the material completely. Further, the transparent window 50 seals the light guide 24 and prevents the entry of fluid from the oral cavity. The proximal end 46 of the light guide 24 engages a collimator 34 in a manner similar to that depicted in FIG. 2. A bitewing 32 (depicted only in FIG. 2) may be removably attached to the distal end 44 of the light guide 24 to correctly position the light guide 24 over the area to be treated to provide efficient distribution of light.

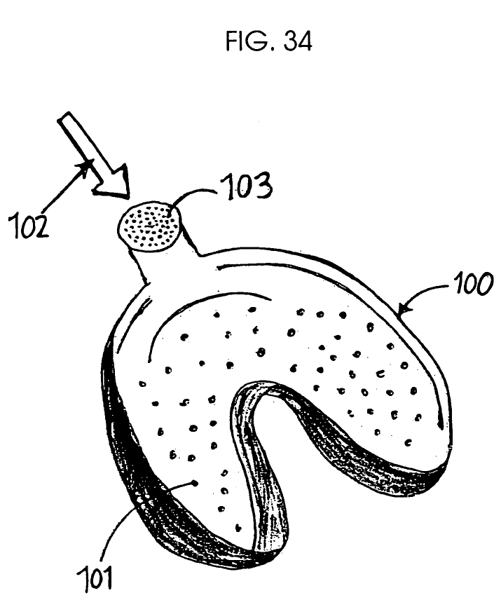

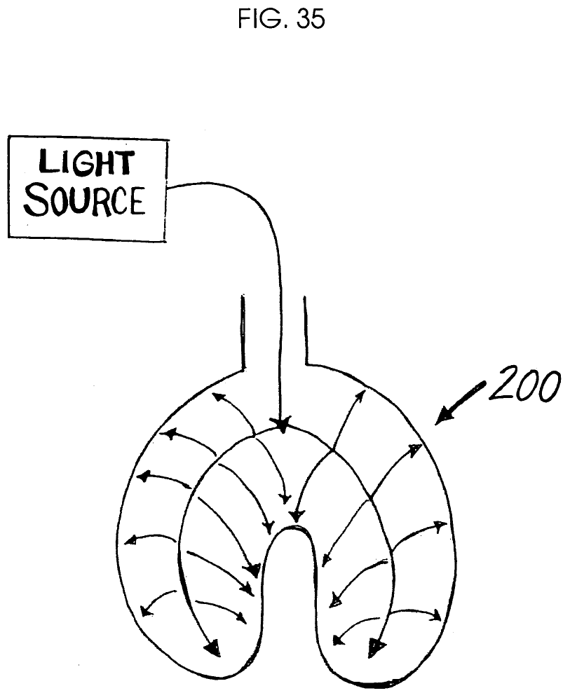

In another embodiment, which is depicted in FIG. 34, a mouthpiece 100 with a plurality of optical fibers 101 spaced relatively uniformly therein is attached to the light source. The light 102 from the light source is channeled to the mouthpiece through the optical fiber bundle 103, which distributes light from the light source to one or more of the optical fibers 101. Upon application to the oral cavity, light is delivered to the buccal and lingual sides of the gums.

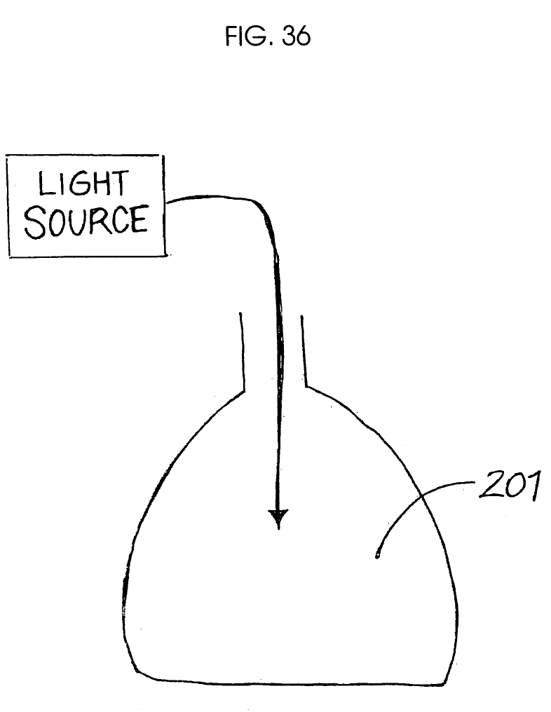

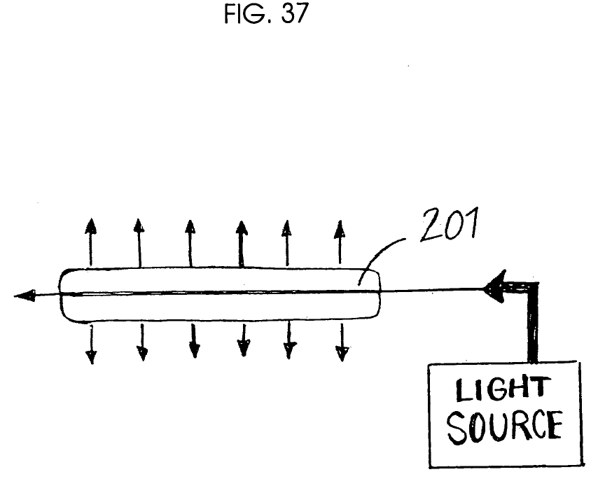

In another embodiment, there is disclosed a device to illuminate the teeth and gums with light that has therapeutic properties. Such device has a light distributor that can illuminate both the upper and lower arches simultaneously, as well as both the lingual and buccal sides of the teeth and gums. Referring to FIG. 35, the device 200 illuminates relatively uniformly in both directions from a flat or nearly flat plane, bathing the teeth and gums in light that is channeled, directed or piped into device 200 from outside of the mouth. Another embodiment is that the light emitted from device 200 is from a source self-contained with device 200. Alternatively, the light can come from a pattern of LEDs distributed on the surface of bidirectional flat plate 201 (FIGS. 36, 37). Still another embodiment is the use of an electroluminescent panel or panels to provide the light.

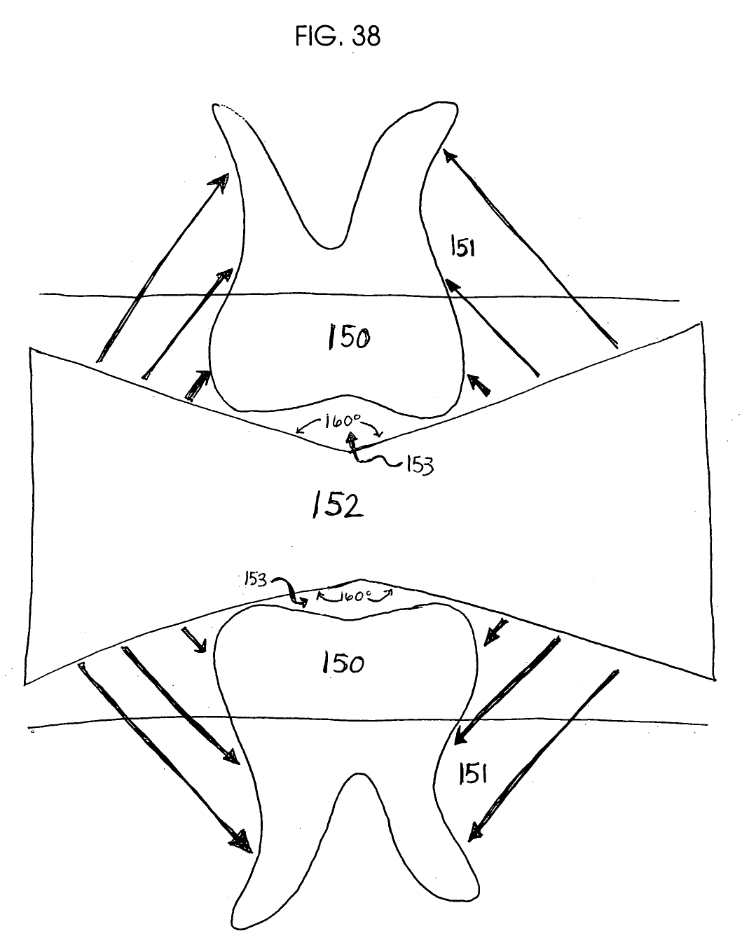

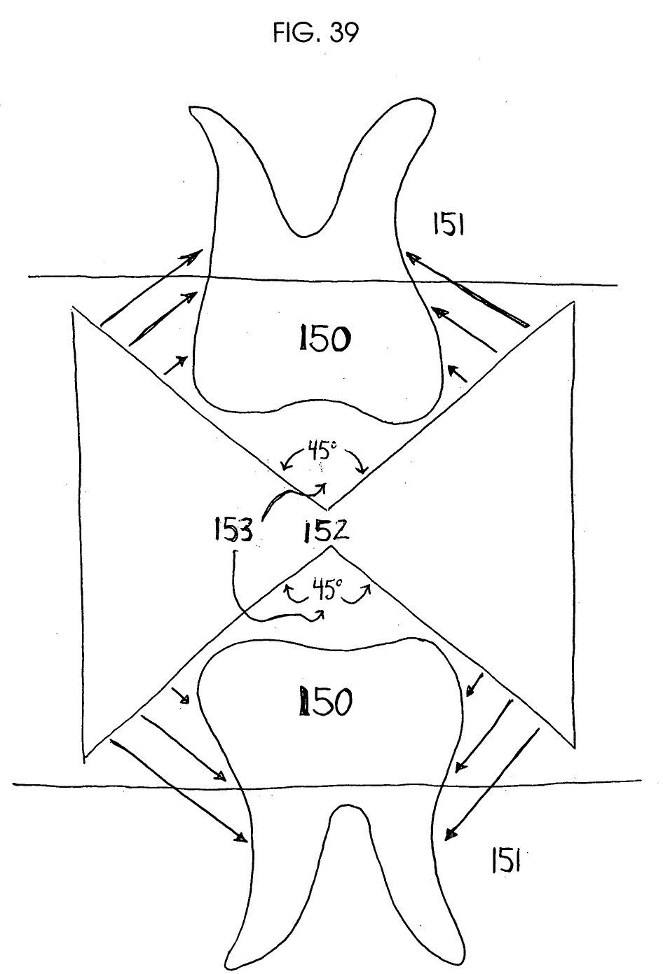

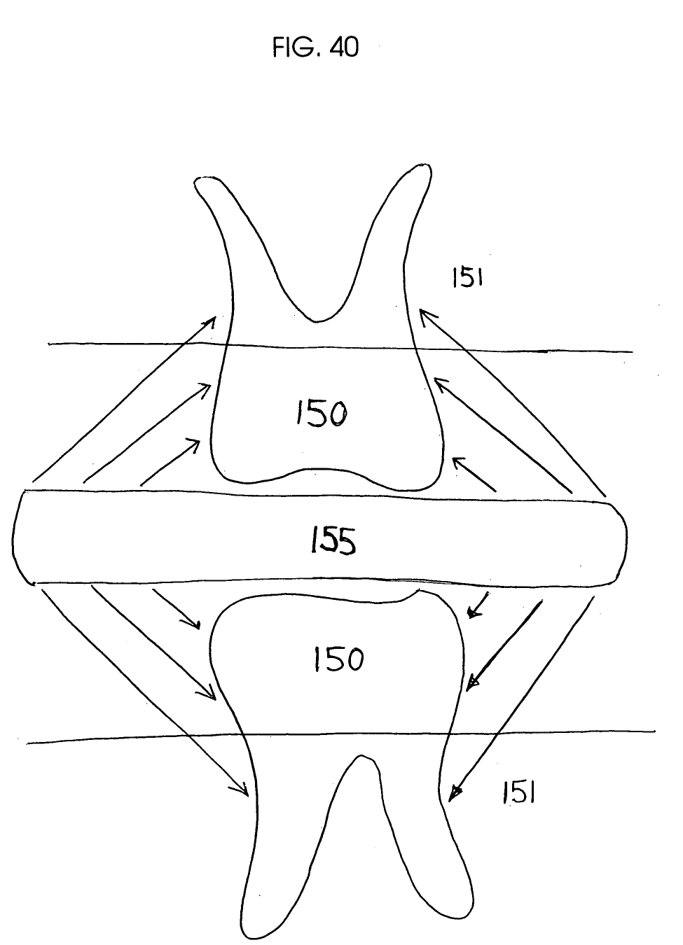

FIGS. 38 and 39 illustrate yet another embodiment, comprising a bidirectional illuminating plate 152 with V-shaped grooves 153. The incisal edges of the teeth 150 fit into the V-shaped grooves 153 and the illumination from the plate 152 is angled towards the lingual and buccal surfaces of the teeth 150 and gingiva 151. The total angle of each of the V-shaped grooves 153 can be in the range of just under 180° to about 45°, or another angle that would no longer allow for the teeth to fit inside the V-shaped groove 153. In still another embodiment, light is projected at an angle from the surfaces of a flat, bidirectional illumination plate 155. As depicted in FIG. 40, the light is directed towards the teeth 150 and gingiva 151.

The surfaces of plate 201 that can come into contact with the teeth are designed to emit light energy in such a way as to efficiently illuminate the teeth and the gingival margins of a subject or patient. The dentist or patient positions the plate in such a way as to allow for biting down on the plate to hold it in place during the illumination cycle, which could be anywhere from a few seconds (or less than a second, such as with a high intensity flash lamp as an external light source) to an hour or more. A wide range of wavelengths and energy densities are envisioned, depending on the desired therapeutic effect. Light energy between about 350 and 900 nm, or about 400 and 700 nm, or about 400 to 500 nm, has utility in exerting a therapeutic effect.

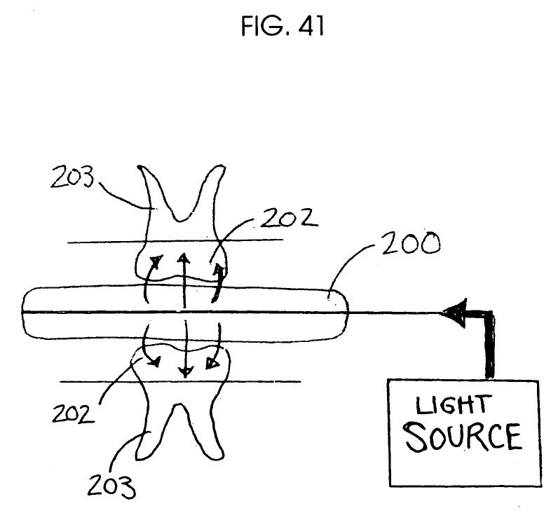

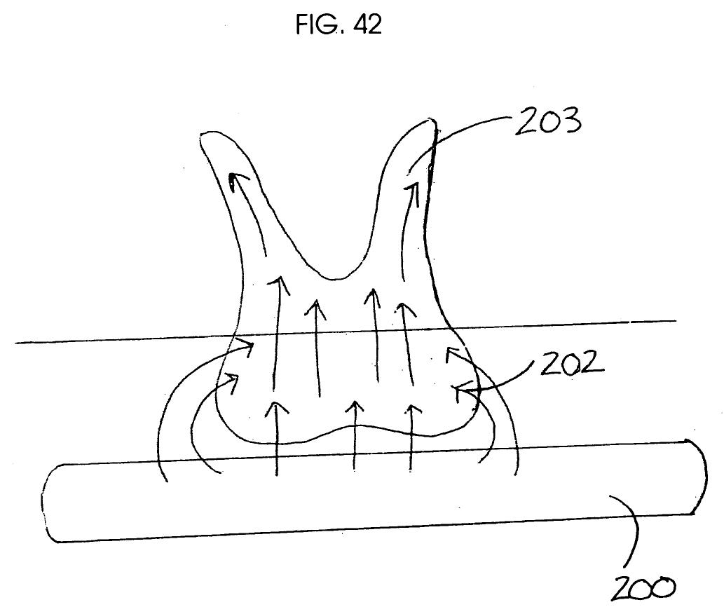

The ability of the tooth itself to “pipe” (i.e., transmit light) certain wavelengths of light up to and in some cases under the gingiva, make for a unique means of illuminating oral structures that are not directly illuminated by the device. In other words, by illuminating just the teeth, or illuminating the teeth with higher intensity light than the gingival tissue, the subgingival tissue may also gain therapeutic benefits due to the unique light transmitting properties of tooth enamel and dentin. This mechanism is illustrated in FIGS. 41 and 42, although it applies to all devices disclosed herein. As shown in FIG. 41, device 200 or 201 (FIGS. 35 and 36) delivers light to significant portions of the teeth 202 and gums 203 (buccal and lingual sides). The light is then transmitted bidirectionally. As shown in FIG. 42, the light is also piped through the teeth 202 into the gums 203.

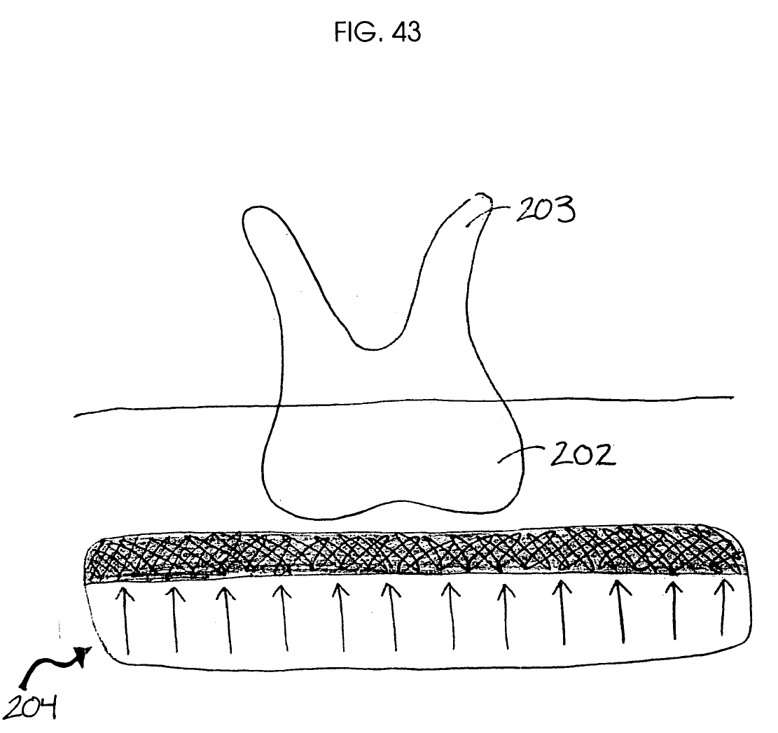

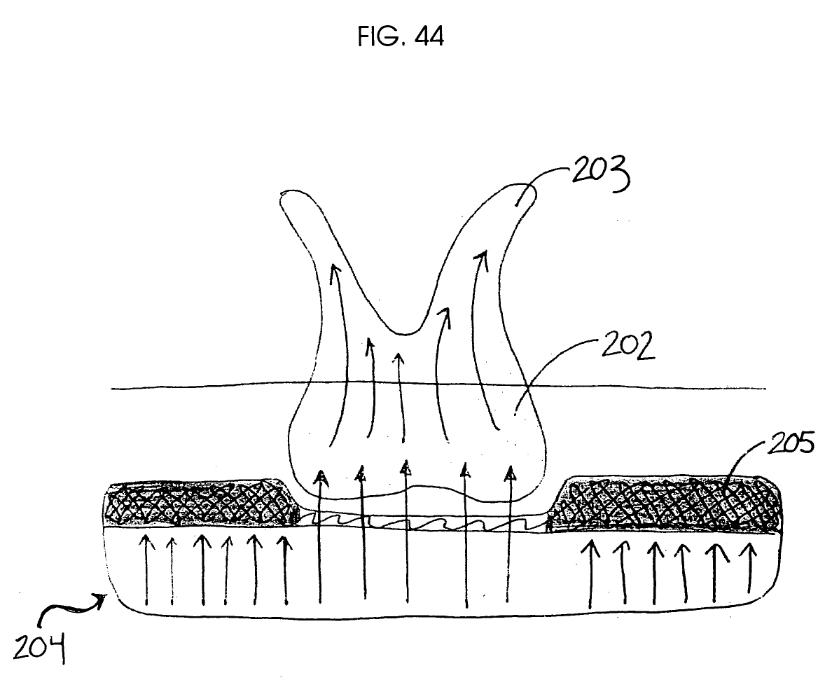

It is also possible to provide a means of “gating” the light that emerges from the plate by employing a tooth-sensitive gate 204 (FIGS. 43, 44) that only allows light through when the teeth 202 are exerting pressure on a particular point on the plate. This embodiment(s) is illustrated in FIGS. 43, 44 wherein flexible illuminating plate 204 emits light against and through the tooth surface.

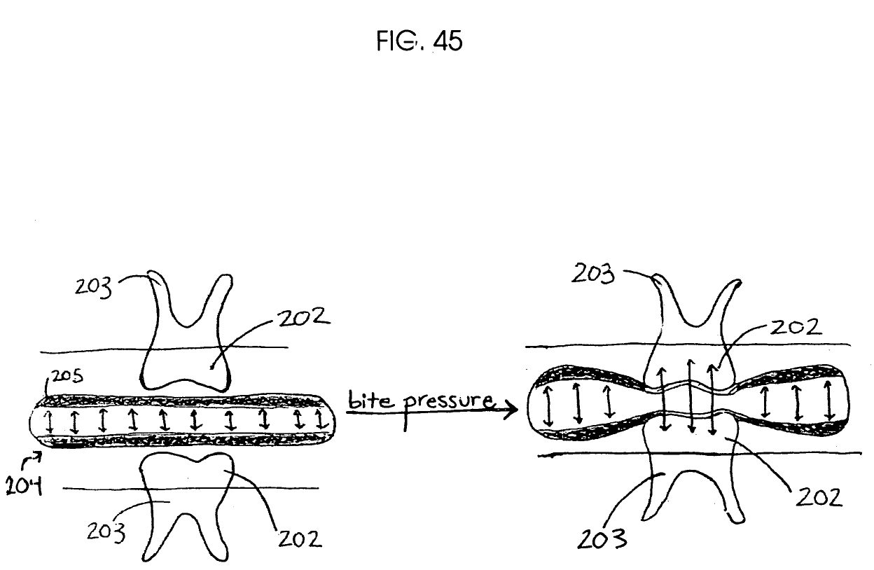

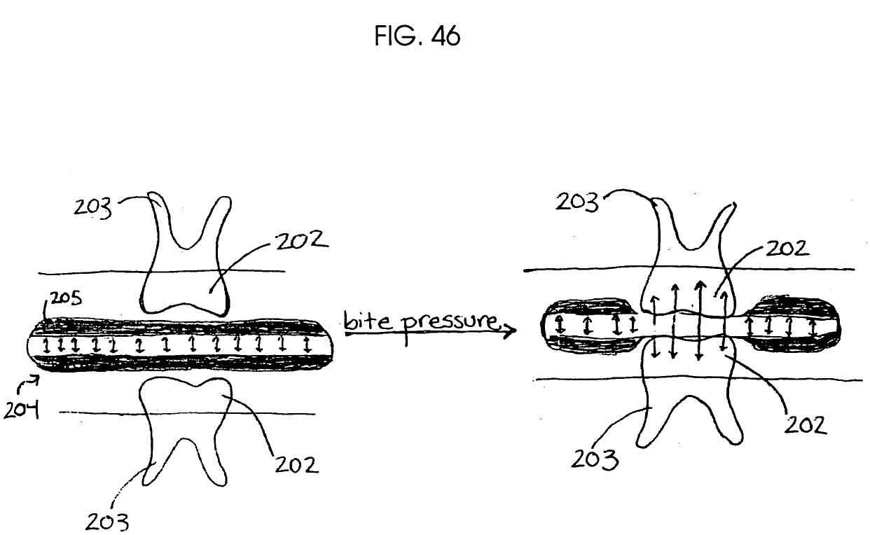

As shown in FIG. 44, gating type plate 204 is provided comprising a light-emitting layer covered by an opaque layer 205 that is sufficiently flexible to allow the pressure exerted by the teeth biting down on the surface of opaque layer 205 to thin or flatten it in order to increase its transparency. Whereas the opaque layer 205 may be impermeable to light in its normal, uncompressed state (for instance, approximately 1-2 mm thick), when pressure is applied to the opaque layer it thins out and allows for more light to be “gated” through this layer (which when contacted by teeth under pressure may thin out to about, 0.1-0.2 mm or less). In one embodiment, there is a rigid inner light-emitting layer and at least one surface of the rigid inner layer is covered with a flexible, opaque outer layer 205 that comes in contact with the teeth 202 and allows light to pass through it when under sufficient pressure to cause thinning and subsequent light transmission. The plate may comprise either one or both surfaces of the light-emitting layer (there being a plane formed by the light-emitting layer that has one face pointing generally in the direction of the maxillary arch and one face pointing generally in the direction of the mandibular arch). Other shapes and profiles are envisioned, such as shown in FIGS. 45-46. Optionally, a contact switch may be included that triggers or completes an electrical circuit, such that only when a patient bites down on the illuminating plate does the light turn on and emit from the device. Further, the contact switch may be connected to a timer, which would only allow light to be emitted from the plate for a predetermined interval of time.

The opaque gating layer may be a flexible polymer or elastomer such as an ethylene vinyl acetate copolymer or styrene-butadiene-styrene block copolymer with dispersed light-blocking agents or fillers, such as titanium dioxide or zinc oxide. Alternatively, the opaque gating layer may be a liquid or gel such as a silicone fluid with dispersed light blocking agents or fillers encased in a leak proof flexible outer casing that is integrally attached to the underlying rigid illuminating plate. The rigid illuminating plate may be a non-flexible or minimally flexible polymer such as PMMA, polycarbonate, acrylic, or other suitable light-transmitting material.

Rigid, for the purposes of this invention, means less flexible than the flexible gating opaque layer, if any, described above. The rigid light-emitting layer or plate should be of sufficient harshness and structural integrity to maintain its original shape until placed into the oral cavity. In general, and when there is an inner light-emitting layer and an outer, separate opaque gating layer, the inner layer should be more rigid than the outer layer or layers. This allows for the compression of the outer layer to cause the necessary thinning of this layer for gating the light, and the inner layer should be rigid enough to resist said thinning pressure.

In another embodiment, a light source is attached to an auxiliary and/or therapeutic physical or mechanical device, such as a toothbrush, an interproximal stimulator, an oral irrigator, or a power flosser. The light may be included in already existing electric toothbrush, oral irrigator or power flosser technologies, for example, those marketed by Oral B®, Sonicare®, Procter & Gamble, Colgate-Palmolive, Water-Pik and Johnson & Johnson, the disclosures of which are incorporated herein by reference. For example, the light may be placed in a replaceable head or in a reusable base. In one embodiment, the light is channeled to the bristle and out of the head. When the light source is located in a replaceable head, the light path is shortened and the power requirements will not be as high because there will be less heat to dissipate. Such a design may require a mechanical connection (alternatively an ultrasonic link) between the base and the replaceable head to drive the bristle motion and a separate electrical connection to power the light source in the replaceable head. In another embodiment, the mechanical connection between the base and the replaceable head that drives the bristle motion can be used to drive a miniature electrical generator that in turn powers the light source in the replaceable head.

In another embodiment, a comprehensive illumination device may be used as a professional device that bathes all oral surfaces with light to produce a generalized ecological change in microbial habitation. For example, the BriteSmile 2000™ BriteSmile 3000™ plasma arc lamps, and BriteSmile 3000PB™ disclosed in U.S. Pat. No. 6,416,319 and PCT WO 01/26576 may be utilized to deliver light to the oral cavity. The BriteSmile 2000™ is an integrated light source and delivery system in which a fixed light delivery head delivers energy-efficient light of selected wavelengths to the teeth. The lamp module, of both the BriteSmile 2000™ and BriteSmile 3000™, comprise one or more metal halide lamps with integrated power supplies. The BriteSmile 3000PB™ utilizes LEDs as a light source and is functionally similar to the BS2000™ and BS3000™ systems.

As is the case with all device embodiments herein, the light source can be positioned in a manner to deliver light to any surface of the oral cavity (e.g., teeth, gums (buccal and/or lingual) and tongue). The positioning of the light source, more specifically the surface or surfaces of the device that emit the therapeutically effective light, in relation to the tooth and/or gum surface to be treated, can be facilitated by using one or more of a patient's oral anatomical features or structures as a positioning means. For example, a device may be positioned in the oral cavity by providing a biting surface on which the patient or subject exerts biting pressure in order to orient the light-emitting surfaces in relation to the tooth and/or gums. Alternatively, an interproximal space between two adjacent teeth may be used to position a guide structure that orients a device's light-emitting surfaces to optimize the therapeutic effects of the light. In another embodiment, the aforementioned biting surface and/or guide structure may also serve as a device's light emitting surface. Further, all such devices may also be utilized with tooth-whitening compositions for tooth-whitening methods as is known in the art.

The device for administering light to the oral cavity can have a high optical efficiency to prevent the loss of energy out of the oral cavity. Preferably, the optical efficiency should range from about 50% to 100%, more preferably from 75% to 100%.

Depending on the intended area of the oral cavity to be treated, the device may apply the light to the subject's teeth, gums, and/or tongue. In the devices, the light may be applied separately to different portions of the oral cavity. For example, the device may be designed to cover one-fourth to one-half of the upper and lower teeth and gums, more preferably one-third of the upper and lower teeth and gums. Alternatively, the light source may be incorporated with a tongue depressor for applying light to the tongue to control halitosis, for example. In another embodiment, light is applied simultaneously to substantially all of the subject's upper and/or lower teeth and gums with the use of a horseshoe-shaped mouthpiece. The horseshoe-shaped mouthpiece serves as the light distributor which is connected to a light source outside the oral cavity. The horseshoe-shaped mouthpiece will have a shape that follows the arch, with the light distributor parallel to the buccal surface of the teeth, the lingual surface of the teeth, or along the bite plane. In one embodiment, light is applied to the subject's actual tooth structure, such as with a horseshoe-shaped mouthpiece that distributes light along the bite plane. The tooth structure may be used as an illumination target, thereby taking advantage of the light diffusion characteristics of the enamel and the dentin to channel the light to the interface between the tooth and gum subgingivally. This may be an effective means of transporting light to the precise location where the periodontal disease organisms thrive (subgingival pockets), without direct illumination of the outside surface of the gums. This is beneficial because direct illumination of the outside surface of the gums may be somewhat inefficient, due to the light-blocking properties of the gingival soft tissue. For example, a flat plate, which serves as the light distributor, may be inserted into the oral cavity with the light source 12 remaining outside of the oral cavity. The light distributor of the flat plat may radiate the light in an upward and downward direction to cover both the upper and lower teeth. The light distributor of the flat plate may radiate light perpendicularly or at 90 degrees to the surface of the plate, or at an angle other than 90 degrees to the surface of the flat plate.

The device may be placed between the subject's cheek and gum. The subject then applies the device to each portion of the oral cavity. In one embodiment, the device is configured to target three zones in the oral cavity. Two zones are symmetrically opposed in the rear of the oral cavity and include the molars and premolars. The third zone is centered on the front of the oral cavity and covers the four incisors and two canines of the upper jaw. In using the Universal Tooth Numbering System (described at http://www.ada.org/public/topics/tooth_number.asp), one embodiment covers approximately one-third of the upper and lower arches at a time and thus approximately covers teeth numbered 1-6 and 27-32 in one illumination period, then 6-11 and 22-27 in a second illumination period, and lastly 11-16 and 17-22. Teeth numbers 1, 32, 16, and 17 are wisdom teeth and may not be present in a patient's oral cavity. In one embodiment, the surface area covered in each zone may range from about 4.5 to 7.5 cm², or about 6.6 cm² (i.e., about 3.3 cm² on each of the upper and lower teeth and gums). The subject may place the device 10 into the oral cavity at a horizontal angle, similar to a toothbrush, so that the device faces the buccal surfaces of the teeth. Light is emitted from the light pipes 22 to the teeth and gums at an angle ranging from about 60° to 120°, or from about 75° to 90°, or about 75°.

The wavelength of the light may range from about 350 nm to about 700 nm. In a preferred embodiment, the output is filtered to provide an efficient source of visible blue light in the 380-520 nm range. In one embodiment, light is filtered to be in the 400-505 nm range, or about 475 nm in one embodiment. In another embodiment, the light source is an LED emitting blue light in the range of about 430 nm to about 510 mm, the peak being either about 455 nm or about 470 m (blue light). In another embodiment, the light source is a gas plasma arc emitting visible light in the range of about 380 nm to about 520 nm visible light. In one embodiment, the light from the light source is not filtered. In another embodiment, the wavelength is about 455 nm. In one embodiment, the wavelength is 380 nm, 385 nm, 390 nm, 395 nm, 400 nm, 405 nm, 410 nm, 415 nm, 420 nm, 425 nm, 430 nm, 435 nm, 440 nm, 445 nm, 450 nm, 455 nm, 460 nm, 465 nm, 470 nm, 475 nm, 480 nm, 485 nm, 490 nm, 495 nm, 500 nm, 505 nm, 510 nm, 515 nm, or 520 nm.

The intensity (energy density) of the light may range from about 1 mW/cm² to about 1000 mW/cm² or higher, or about 1 mW/cm² to about 800 mW/cm², or from about 1 mW/cm² to about 200 mW/cm², or from about 1 mW/cm² to about 120 mW/cm², or about 20 mW/cm². In another embodiment, the power density, or energy delivered to the teeth, is adjusted to a setting of between about 100 mW/cm to about 160 mW/cm², or, from about 130 mW/cm to about 150 mW/cm². The intensity of the light may be diminished as optical efficiency increases. For example, the LED emitters 16 are capable of producing total luminous power of up to 500 mW each. In one embodiment, the clinical objective may be to irradiate the oral cavity target with luminous intensities of between about 50 to about 100 mW/cm² to transfer a total of up to about 300 mW to an area of 3 cm². Three such LED emitters 16 may be used to generate the total energy needed to suitably irradiate the upper and lower regions of the oral cavity simultaneously.

The duration of exposure of the light to the teeth and/or gums may range from about 5 seconds to about an hour, or about 5 seconds to about 15 minutes, or about 5 seconds to about five minutes, or about 5 seconds to about two minutes, or from about 5 seconds to one minute. The duration of exposure may be specifically 5 seconds, 10 seconds, 15 seconds, 30 seconds, 45 seconds, one minute, two minutes, three minutes, four minutes, five minutes, 10 minutes, 15 minutes, 20 minutes, 30 minutes, 40 minutes, 50 minutes, or one hour. The light source may automatically turn off after the duration of application. As higher light intensity is reached, the duration of exposure may decrease. In one embodiment, the device 10 is placed in the oral cavity for no longer than 2 minutes. When the device 10 is applied to more than one portion of the oral cavity with each use, the total time remains at no longer than 2 minutes. The device 10 may include a timer or an electronic signal, such as a light flashing or a pulse vibration, which indicates to the user to rotate to the next position.

The frequency of application of light to the oral cavity may be on a daily, weekly, monthly, or annual basis. When the method of the present invention is performed at home by the subject, the subject exposes the light source to the oral cavity for the selected time period for about 1, 2, 3, 4, 5, or 6 times every day, week, month, or year for the selected period of time. For example, the period may range from about two weeks to about one month, six months, nine months, or one year. When the method of the present invention is performed in a dental office, the method may be performed by a dental professional at least 1, 2, 3, 4, or 5 times a year in less than about 20 minutes, or in less than about 10 minutes, or in less than about 5 minutes. The application of light may be intermittent, pulsed, or continuous with each application.

In another embodiment of the present invention, an oxidizing agent administered to the oral cavity of the subject selectively eliminates or reduces bacteria and improves oral health. Improvement in oral health through the application of an oxidizing agent may be accomplished during a tooth whitening treatment, for example, or as an independent therapeutic treatment. The oxidizing agent may include, but is not limited to, hydrogen peroxide (and any hydrogen peroxide precursor), although any peroxide may be selected from the group consisting of hydrogen peroxide, carbamide peroxide, calcium carbonate peroxide, sodium carbonate peroxide, sodium percarbonate, calcium peroxide, sodium perborate, potassium persulfate, peracetic acid (and other peracids), chlorine dioxide, and other oxygen radical generating agents. In one embodiment, the oxidizing agent composition comprises from about 5.0% (w/w) to about 35.0% (w/w) hydrogen peroxide. Other oxidizing agent compositions comprise from about 3.0% (w/w) to about 20.0% (w/w) hydrogen peroxide. Other oxidizing agent compositions comprise from about 6.0% (w/w) to about 15.0% (w/w) hydrogen peroxide. In one embodiment, the oxidizing agent composition is BriteSmile Tooth Whitening Gel™. Other whitening gels are those described in U.S. Pat. Nos. 5,922,307 and 6,343,933. In another embodiment, an oxidizing agent may be applied to the tooth and/or gum surfaces through the use of a transparent plastic strip such as Crest Whitestrips®. Following placement of a transparent strip containing a thin layer of a transparent composition comprising an oxidizing agent, a therapeutically effective amount of light may be applied through the transparent strip and transparent oxidizing composition onto the tooth and/or gum surfaces.

Calcium and iron chelators as are generally known in the art may also be included with the oxidizing agent to eliminate or reduce bacteria in the oral cavity, or to make the bacteria more susceptible to killing by light. Suitable chelating agents include but are not limited to EDTA and its salts, citric acid and its salts, gluconic acid and its salts, etidronic acid (Dequest 2010), alkali metal pyrophosphates, iron chelating agents and other compounds capable of sequestering or chelating iron, and alkali metal polyphosphates. Alternatively, a composition comprising an iron chelator may be used alone or in combination with an oxidizing agent to increase the susceptibility of oral bacteria to light.

In yet another embodiment of the present invention, application of an oxidizing agent to the oral cavity with subsequent exposure to a light source improves the oral health of a subject by selectively eliminating bacteria in the oral cavity. Any combination of the light devices and oxidizing agents described above may be utilized to accomplish the goals of the present invention.

The oxidizing agent composition is applied at about 1.0 to about 2.0 millimeters thick on the surface of the subject's teeth, preferably using a syringe. In one embodiment of the invention, once the oxidizing agent composition is applied, a light source is positioned in front of the subject's oral cavity. Once the light source is positioned, approximately 20 minutes of light is applied, at which point the oxidizing agent composition will be suctioned off the oral cavity and replaced for a second approximately 20-minute light exposure period. The treatment cycle is repeated a total of three times, for a total procedure time of approximately 60 minutes (excluding isolation).

The method of the present invention comprises improving the oral health of a subject by administering a therapeutically effective amount of light and/or peroxide. In one aspect of the present invention, the oral health of a subject may be improved by administering a therapeutically effective amount of light under a predetermined set of parameters. The therapeutically effective amount of light may be administered to the entire mouth or may be limited to the lingual surfaces of the teeth and gums, the buccal and/or lingual surfaces of the teeth and gums, or the upper surface of the tongue. Several parameters are outlined above, including duration of exposure and frequency of application.

For example, the therapeutically effective amount of light may be administered at a predetermined wavelength as provided above. The therapeutically effective amount of light may further include one or more predetermined wavelengths, for example in the range of from about 350 nm to about 700 nm.

Additionally, therapeutically effective amounts of light may be administered in a predetermined dosage. The predetermined dosage may range from about 0.1 Joules/cm² to about 1000 Joules/cm², or from about 0.1 Joules/cm² to about 500 Joules/cm², or, from about 0.1 Joules/cm² to about 100 Joules/cm², or, from about 0.1 Joules/cm² to about 50 Joules/cm², or, from about 0.1 Joules/cm² to about 10 Joules/cm². In one embodiment, the dosage is from about 0.2 Joules/cm² to about 1.2 Joules/cm². In another embodiment, the dosage is about 4.2 Joules/cm². In still another embodiment, the dosage is about 21 Joules/cm². In yet another embodiment, the dosage is 2 Joules/cm², 3 Joules/cm², 4 Joules/cm², 5 Joules/cm², 6 Joules/cm², 7 Joules/cm², 8 Joules/cm², 9 Joules/cm², 10 Joules/cm², 11 Joules/cm², 12 Joules/cm², Joules/cm², 14 Joules/cm², 15 Joules/cm², 16 Joules/cm², 17 Joules/cm², 18 Joules/cm², 19 Joules/cm², 20 Joules/cm², 21 Joules/cm², 22 Joules/cm², 23 Joules/cm², 24 Joules/cm², 25 Joules/cm², 26 Joules/cm², 27 Joules/cm², 28 Joules/cm², 29 Joules/cm², 30 Joules/cm², 31 Joules/cm², 32 Joules/cm², 33 Joules/cm², 34 Joules/cm², 35 Joules/cm², 36 Joules/cm², 37 Joules/cm², 38 Joules/cm², 39 Joules/cm², 40 Joules/cm², 41 Joules/cm², 42 Joules/cm², 43 Joules/cm², 44 Joules/cm², 45 Joules/cm², 46 Joules/cm², 47 Joules/cm², 48 Joules/cm², 49 Joules/cm², or 50 Joules/cm^{2.}

The therapeutically effective amount of light may have one of several beneficial health benefits including, but not limited to, an anti-inflammatory effect, an anti-bacterial effect, a sterilizing effect, a pain-relieving effect, an increased immune response effect, and a periodontal improvement effect. The therapeutically effective amount of light may be used for prevention and treatment purposes.

In another aspect of the present invention, a therapeutically effective amount of an oxidizing agent is administered to the oral cavity of the subject prior to administering the therapeutically effective amount of light to the oral cavity of the subject. In yet another aspect of the present invention, a therapeutically effective amount of cleaning agent is administered to the oral cavity of the subject prior to administering the therapeutically effective amount of light to the oral cavity of the subject. The cleaning agents may be mechanical (such as an abrasive) or chemical in mode of action. Such cleaning agents may include but are not limited to toothpastes, mouthwashes, and active agents delivered from floss.

In one embodiment, exposure of the oral cavity to light alone selectively eliminates or reduces bacteria from the oral cavity. The therapeutically effective amount of light eliminates from about 5% to about 25%, about 5% to about 50%, about 5% to about 75%, or about 5% to about 100% of all bacteria present in the oral cavity. In another embodiment, from about 5% to about 25%, about 5% to about 50%, about 5% to about 75%, or about 5% to about 100% of black-pigmented bacteria in the oral cavity is eliminated after exposure to light.

Long-term effects on periodontal health may occur only by changes in microbial ecology. Measurements of microbial changes are, therefore, indicators of the efficacy of the methods of the present invention. Microbial composition may be determined by DNA:DNA hybridization. These methods require only that bacteria be scraped from the tooth surface, placed into a vial and taken to the laboratory. From that sample, the 40 representative bacteria disclosed in Table 1 are identified and quantified by established methods. Changes in the levels or proportions of these bacteria may be clear indicators of ecologic change.

It is believed that one skilled in the art, based on the description herein, can utilize the present invention to its fullest extent. The following specific examples are therefore to be construed as merely illustrative, and not limitative of the remainder of the disclosure in any way whatsoever.

### EXAMPLES

### Example 1

This example demonstrates the results on oral health of a six-month parallel-design, blinded clinical evaluation of a one-time, in-office, light only, peroxide only, and combination peroxide-and-light procedure conducted in accordance with ADA guidelines.

Materials and Methods

The light used (BriteSmile 2000, BriteSmile, Walnut Creek, Calif.) was a stationary, short-arc gas plasma lamp emitting light in the blue-green (400-505 nanometers) portion of the color spectrum. The lamp simultaneously illuminated all the incisors. One of the researchers calibrated light irradiance daily using a standard light meter, set to a level of 130 to 160 mW/cm² measured at a standard working distance of about 1.75 inches. Although irradiance was measured on only one portion of the emitter, all anterior teeth received approximately the same irradiance because the shape of the emitting surface approximated that of the dental arch. The peroxide gel contained about 15% hydrogen peroxide in a pH 6.5 hydrogel. The placebo gel was the same hydrogel vehicle without peroxide.

Experimental Design

All subjects received a detailed informed consent form that outlined all procedures, defined alternatives, and indicated that they could be assigned to a placebo group. Eighty-seven subjects (38 males and 49 females) with an average age of 44 years (20 years through 67 years) were randomly assigned by the study coordinator to three experimental groups of 29 from a prepared randomization sequence. These groups were the peroxide plus light group (Group 1), which used 15% hydrogen peroxide gel plus light; the peroxide group (Group 2), which used 15% hydrogen peroxide gel alone; and the light group (Group 3), which used light with placebo gel.

Treatment assignment was by randomization in strata of three, as was the sequence of treatments. Treatments were blinded to both the examiner and subject to the extent possible (the lack of a light in Group 2 was not blinded to the subject). Otherwise, all subjects were treated identically. Treatment visits included tooth brushing with a nonfluoridated nonwhitening dentifrice, baseline clinical measurements, tooth isolation, whitening, and post-treatment clinical and color measurements.

Gingival health was measured at four checkpoints (baseline, immediately post-treatment, at three months, and at six months). In accordance with ADA guidelines, examiners measured gingival health using the Gingival Index and Plaque Index. The examiners recorded readings on all maxillary and mandibular teeth from the first molar forward at each evaluation period. Safety was evaluated by both professional oral examination and a subject questionnaire. To ensure protection of the maxillary and mandibular gingival, examiners applied a brush-on isolation material (Opaldam, Ultradent Products, South Jordan, Utah) extending approximately one millimeter onto all tooth surfaces in the treatment area before whitening.

All incisors, canines, and premolars were covered with peroxide or placebo gel depending on their experimental group. The light was positioned according to the manufacturer's instruction using the integral bite appliance guide to set the distance between the teeth and the light source. All treatments lasted one hour. The hydrogel was applied every 20 minutes so that the tooth surface was never dry.

Statistical Analysis

All subjects were analyzed as part of the groups to which they were randomized.

Results

The Gingival Index of all groups decreased significantly after therapy with no change in Plaque Index (Table 2). The Gingival Index in all treatment groups was significantly less than baseline through six months, including the group treated by light alone.

TABLE 2
SUBJECTS' (N = 29) AVERAGE SCORES ON GINGIVAL
AND PLAQUE INDEXES

| | | SCORE (±SEM*) AT | | |
|---|---|---|---|---|
| MEAS- | | MEASUREMENT PERIOD | | |
| UREMENT | TREATMENT | Baseline | 3 Months | 6 Months |
| Gingival | Peroxide and | 0.64 ± 0.29 | 0.33 ± 0.34^{†} | 0.28 ± 0.30^{†} |
| | light | | | |
| Index | Peroxide | 0.65 ± 0.37 | 0.44 ± 0.32^{†} | 0.39 ± 0.37^{†} |
| | Light | 0.70 ± 0.31 | 0.49 ± 0.31^{†} | 0.55 ± 0.36^{†} |
| Plaque | Peroxide and | 0.17 ± 0.05 | 0.17 ± 0.05 | 0.14 ± 0.03 |
| | light | | | |
| Index | Peroxide | 0.12 ± 0.03 | 0.11 ± 0.04 | 0.14 ± 0.05 |
| | Light | 0.08 ± 0.03 | 0.16 ± 0.04 | 0.16 ± 0.05 |

*SEM: Standard error of the mean for 29 subjects.
^{†}Significantly different from baseline (P < .01, Friedman analysis).

Discussion

Gingival Index values represent a measure of tissue irritation. Rather than increasing, as might be expected after topical application of potentially irritating substances, Gingival Index measurements significantly decreased over the three- and six-month periods, suggesting that the treatment procedures reduced gingivitis.

At the same time, plaque index (Silness and Loe 1964) was evaluated. In this case, patients came in with low levels of visible plaque (the average plaque index being approximately 0.1) and low levels were maintained throughout the study and were not affected by therapy.

Taken together, these data suggest that treatment with light plus peroxide, light only, and peroxide only all significantly reduced gingival inflammation without materially affecting the amount of visible plaque. Since the effect persisted for up to 6 months following a single application, it is likely that the treatments altered the bacterial composition of the periodontal environment to one more favorable to periodontal health.

### Example 2

This study demonstrates the specificity of action of visible light on oral black-pigmented bacteria. It was hypothesized that oral black-pigmented bacterial of the Prevotella and Porphyromonas genera could be selectively inactivated by exciting their naturally synthesized endogenous porphyrins with broadband visible light (380-520 nm).

Methods

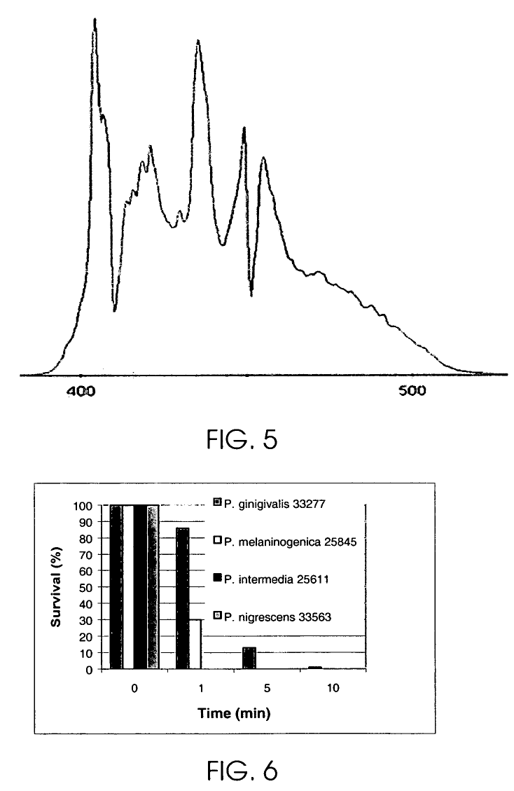

Pure cultures of Porphyromonas gingivalis, Porphyromonas melaninogenica, Prevotella nigrescens, and prevotella intermedia were exposed to 380-520 nm visible light from a high intensity light source (irradiance: 130 mW/cm²) for one, five, and ten minutes (the source optical spectrum is shown in FIG. 5).

After illumination, serial dilutions were prepared in brain heart infusion broth and 100 μl aliquots were spread over the surfaces of blood agar plates. Survival fractions were calculated by counting the colonies on the plates and dividing by the number of colonies from dark controls kept at room temperature for a period equal to irradiation times. In case of dental plaque, microbial analysis was performed by a DNA checkerboard assay using whole genomic probes to 40 oral microorganisms. Proportions of each organism were computed by dividing the numbers for each species by the sum of all bacteria.

In a second study, dental plaque was collected from 20 patients with chronic periodontal disease. Microbial analysis was performed by a DNA checkerboard assay using whole genomic probes to 40 oral microorganisms. Proportions of each organism were computed by dividing the numbers for each species by the sum of all bacteria.

Results

Light produced 100% killing of strains of P. nigrescens and P. intermedia within one minute as shown in FIG. 6. P. melaninogenica was fully eliminated after five minutes of exposure, whereas >99% of P. gingivalis was inactivated within ten minutes (FIG. 6).

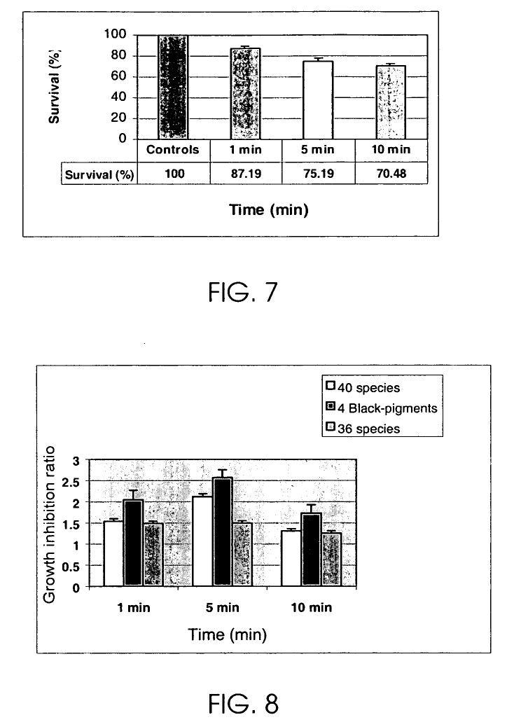

As shown in FIG. 7, when dental plaque samples were exposed to light for one, five, and ten minutes, killing was 13%, 25%, and 30% respectively. Most of the killing occurred between one and five minutes. It is possible that most species with endogenous porphyrins, or any other chromophores, were inactivated within the first five minutes of irradiation.

Bacterial growth was inhibited after exposure to light as shown in FIG. 8. The bars represent the ratios of DNA probe counts obtained before and after irradiation. The most striking effect of light occurred at five minutes. At this time point there was more than 60% reduction of DNA counts for the black-pigmenting bacteria (there were 2.5 times more black-pigmenting species before treatment), whereas the other 36 species showed a reduction of 35%. It is possible that some of these species also have endogenous chromophores that are activated by light, leading to cell death.

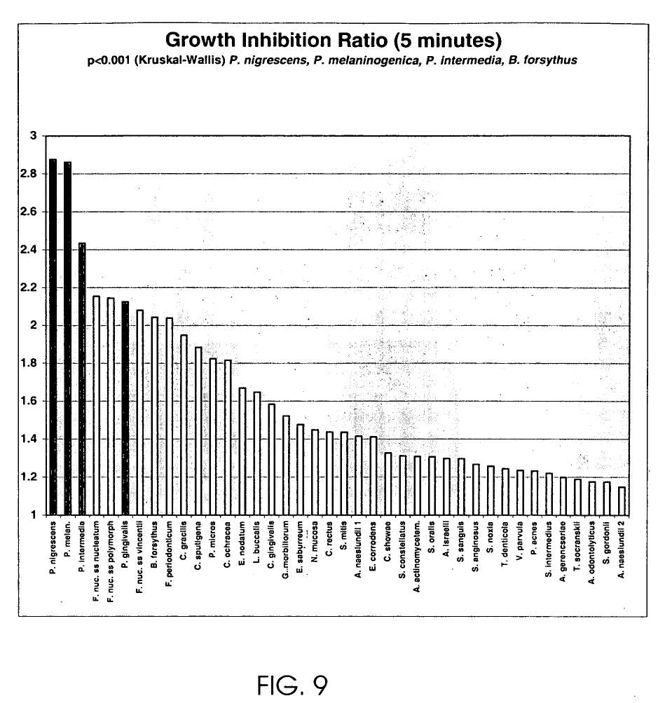

The growth inhibition of each of the 40 species at five minutes of illumination is shown in FIG. 9. Prevotella nigrescens, Porphyromonas melaninogenica, and Prevotella intermedia are mostly affected by light. Porphyromonas gingivalis belongs to a second group of 15 species that show susceptibility to light.

Conclusions

Broadband light from 380 to 520 nm appears to selectively inactivate or eliminate black-pigmented species. While not intended to be bound by one theory, this selective elimination of black-pigmented species may lead to a healthier microbial balance in the plaque environment and therefore, to control disease.

### Example 3

The purpose of this study was to test whether the Prevotella and Porphyromonas genera can be selectively inactivated by exciting their naturally synthesized endogenous porphyrins with visible light (400-520 nm).

Methods

Suspensions of two oral black-pigmented species (P. gingivalis, P. intermedia) and S. constellatus were exposed to five different light sources. The light sources included: BriteSmile™ 2000/3000 380-520 nm (8 J/cm² and 40 J/cm²), BriteSmile 3000 PB 430-520 nm (4.3 J/cm² and 21.5 J/cm²), Red light 665 nm (42 J/cm²), Blue LED 420 nm (36 J/cm²), and Blue LED 400 nm (1.5 J/cm² and 15 J/cm²).

Results

Table 3 provides the percent of killing of bacteria after exposure to several different light sources.

TABLE 3

| | BS | | BS | | Red | Blue | Blue | |
|---|---|---|---|---|---|---|---|---|
| | (380-520 nm) | | (430-520 nm) | | (665 nm) | (420 nm) | (400 nm) | |
| | 1 min. | 5 min. | 1 min. | 5 min. | 7 min. | 10 min. | 1 min. | 10 min. |
| | 8 J/cm² | 40 J/cm² | 4.3 J/cm² | 21.5 J/cm² | 42 J/cm² | 36 J/cm² | 1.5 J/cm² | 15 J/cm² |
| P. gingivalis | 84% | 99% | 72% | 100% | 6% | 1% | 17% | 11% |
| | 1% | 93% | 23% | 80% | 26% | 16% | 9% | 6% |
| P. intermedia | 100% | 100% | 98% | 100% | 76% | 97% | 94% | 95% |
| | 100% | 100% | 69% | 98% | 79% | 100% | 53% | 100% |
| S. constellatus | 0% | 17% | 22% | 15% | 3% | 4% | 16% | 16% |
| | 15% | 30% | 4% | 4% | 4% | 2% | 6% | 9% |

The two sets of values describe results from two different experiments.

Conclusion

The BriteSmile 380-520 nm light source was very effective. After five minutes of irradiation (40 J/cm²) at 130 mW/cm², 100% killing of P. intermedia and 99% killing of P. gingivalis was achieved. The BriteSmile 430-520 nm light source achieved 100% killing (21.5 J/cm²) of both species within five minutes.

P. gingivalis was affected only by the BriteSmile 380-520 and BriteSmile 430-520 lights. P. intermedia was affected by all light sources.

### Example 4

The purpose of this study was to investigate the efficacy of an application of peroxide and/or light on periodontal health. The study involved a randomized assignment of subjects to one of four groups: (1) light, (2) light and peroxide, (3) peroxide, and (4) control.

Experimental Design

Subjects were selected with criteria similar to those of Example 1 and randomly assigned to one of each of the four groups. Subjects were monitored for both clinical and microbiological changes for six months.

Clinical measurements and microbiological samples were taken at four visits: at baseline, one week following treatment, one month following treatment, and six months following treatment. In addition, one set of microbiological samples was taken immediately following treatment. Measurements and samples were taken in the order listed.

The rationale for the measurement and sampling times selected was that previous studies indicated that professional prophylaxis will non-discriminately remove approximately 70% of the bacteria leaving approximately 30%. If the peroxide-light treatment had a more selective effect, that may be evident even at the immediate post-treatment sample. Following exhaustive conventional tooth cleaning measures, bacteria rapidly repopulate the teeth so that between three and ten days, the microbiological effects of cleaning can no longer be seen. Tissue effects usually take a bit longer. Certainly by one month one would expect to see changes in periodontal health measurements if they were to occur. Final sampling and measurement at six months were included to provide for reproduction of the original observation in Example 1.

The rationale for selecting the specific measurements recommended for this study correlated with the three desired outcome measurements: reproduction of the original observation in Example 1, evaluation of microbiological changes, and evaluation of tissue responses.

Reproduction of the original observation: Gingival Index and Plaque Index reproduced the principal elements of Example 1.

Microbial changes: Measurement of the standard battery of 40 periodontal bacteria (Table 1) provided a representative analysis of bacterial changes that could occur. For an effect to last for six months following a single treatment, it was assumed that a measurable change in the microbial composition had occurred. An analysis of the changes that occurred in these representative species provided an insight into any other microbial changes that could occur.

Changes in tissue response: Changes associated with each of the four therapies may be seen most clearly by measurement of tissue changes. Many changes in tissue response were evaluated by clinical diagnostics. These measures are those most commonly understood by clinicians. The most common clinically related diagnostic measurement is periodontal probing (pocket depth, attachment level, and bleeding on probing). A special probe with a computer interface was used (i.e., The Florida Probe). This instrument measured changes as small as 0.2 millimeters and made measurements accurately referenced to the incisal edge of teeth (using the disk probe) and, at the same time, controlled the force of probing. Gingival papilla color was measured using a Minolta chromameter. Finally, hydrogen sulfide (“H₂S”) in the periodontal pocket or sulcus was measured as H₂S is the most important odor component of halitosis.

Screening and Selection of the Subjects

Subjects were selected that have gingivitis or even mild periodontitis in the anterior maxillary sextant. Seven sites were tested for bleeding following the protocol defined by the EDBI (EIBI, Caton et al. 1988).

Sites tested were the interproximal papillae of all maxillary anterior teeth to the cuspid-first bicuspid interproximal. By this method, a wooden interdental cleaner (Stim-U-Dent, Johnson & Johnson, New Brunswick, N.J.) was inserted between the teeth from the facial aspect, depressing the interdental tissues one to two millimeters. The path of insertion was parallel to the occlusal plane, with care being taken not to direct the point of the cleaner apically. The cleaner was inserted and removed four times, and the presence or absence of bleeding within 15 seconds was recorded. Subjects were selected based on their having at least three of the seven sites tested that bled.

Treatment Procedure

Three applications of the 20-minute procedure described in Example 1 above were performed on the subjects in all the groups, except the peroxide only group which does not include the use of light. The peroxide-only group was blinded to the fact that it was not receiving light.

Clinical Measurements

Gingival Index and Plaque Index: In order to test the reproducibility of Example 1, the primary outcome variable of this study was the Gingival Index change measured at six months. Also, the size was set to equal that of the initial study (25 people per group; 100 for the entire study). Indices were recorded on all maxillary and mandibular teeth from the first molar forward at each evaluation period. Gingival Index of Loe and Silness (1963); Plaque Index of Silness and Loe (1964).

Gingival Papilla Color: Papilla color was evaluated by a Minolta chromameter and recorded as one chromameter measurement on each papilla from the buccal interproximal between the maxillary cuspid and first bicuspid on the right to the same papilla on the left (seven maxillary buccal interproximal papillae). The papilla color was calculated by using the CIELAB color scale (Commission International de L'Eclairage's international color standard, “LAB”).

Plaque Sample: All visible plaque was harvested from the surfaces adjacent to the buccal gingival margin of eight teeth; maxillary incisors, cuspids, and first bicuspids.

Samples from each tooth were taken using sterile Gracy curettes. In this case, all available plaque was harvested from each of the eight buccal surfaces. Each plaque sample was placed into a labeled individual 1.7 milliliter snap-top centrifuge tube (VWR Cat. 20170-33) containing 0.15 milliliters Tris EDTA buffer. Following the collection of all samples, 0.1 milliliters of 0.5 M NaOH was added to each vial and mixed by vortex with the sample and buffer. This sample was stable at room temperature for up to three months and was safe to transport.

Probe Measurements (Pocket Depth, Attachment Level, and Bleeding on Probing): The depth of the periodontal sulcus or pocket was measured at three sites across the buccal surface on each of the eight test teeth using the Florida periodontal probe.

Controlled force of probing was set to light (approximately 15 grams). Any site bleeding as a result of this controlled-force probe measurement within 15 seconds of probing was recorded as a bleeding site. Following the first-pass measurement of pocket depth, a referenced measure to the incisal edge (attachment level equivalent) was measured using the Florida disk probe. These measurements were taken to an accuracy of 0.2 millimeters.

Pocket H₂S: Occurrence of H₂S in the pocket was determined using the Diamond Probe 2000 (Diamond General Development Corp.). Measurements were taken on the mesio-buccal of each tooth at the eight maxillary interproximal surfaces.

EDBI: The EDBI as described in the screening section was repeated at the end of each visit to determine if any changes in this bleeding index occurred.

Microbial Composition: Samples from plaque were analyzed by DNA:DNA hybridization (Socransky et al. 1994). Prior to analysis, samples were sonicated in a water bath sonicator for one minute followed by boiling for five minutes. The samples were neutralized using 0.8 millimeters of 5 M ammonium acetate. The released DNA were placed into the extended slots of a Minislot (Immunetics, Cambridge Mass.) and then concentrated into a nylon membrane (Boehringer Manheim) by vacuum and fixed to the membrane by exposure to ultraviolet light.

Up to 28 samples of denatured DNA and two standards of each probe species (105 and 106 bacterial equivalents/sample) were applied to each nylon membrane using a Minislot apparatus. The membrane was then rotated 90 degrees and placed into a Miniblotter 45 (Immunetics, Cambridge Mass.). Digoxigen-labeled DNA probes for the 40 periodontal bacteria of Table 1 were hybridized in individual channels of the Miniblotter.

After washing, the resulting hybrids were detected using digoxigenin conjugated to alkaline phosphatase, Attophos substrate, and a Storm Flourimager. The signal intensity of each unknown was compared with the standards on the same membrane to provide counts of individual species to determine the numbers of bacteria found in the extracted DNA of each sample. DNA probes and reagents were adjusted to obtain a detection limit of 1 bacteria and were maintained with increases of ≧10³ bacteria.

Changes in P. gingivalis proportions were further selected for a detailed study as a representative black-pigmented bacterium that would be expected to absorb light.

Results

The application of light and/or peroxide improved overall periodontal health. The specific effects of light and/or peroxide on a subject's oral health are as follows.

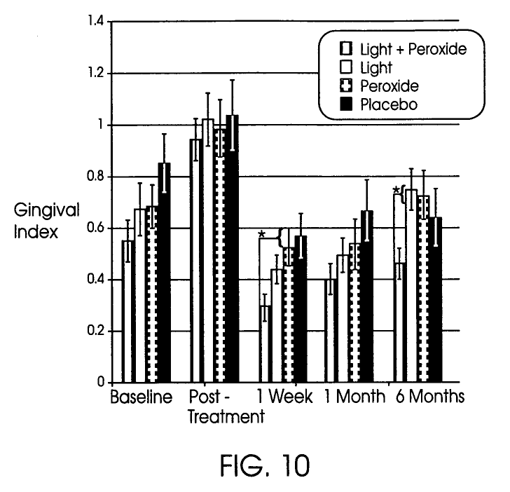

Gingival Index and Plaque Index: As shown in FIG. 10, the Gingival Index increased in all groups immediately after treatment. One week and one month after treatment, however, all groups had Gingival Index levels less than the baseline. At six months, the light plus peroxide group and the control group were less than the baseline. The lowest Gingival Index level of all the groups, at every visit, was the light plus peroxide group. Statistically significant differences were seen one week following treatment where the light plus peroxide group produced the lowest Gingival Index among the control and the peroxide groups.

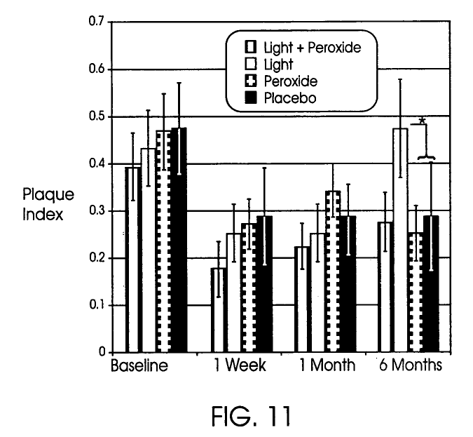

As illustrated in FIG. 11, the Plaque Index of all groups was significantly reduced after treatment. These reductions remained intact throughout the six-month period for all the groups, except the light-only group

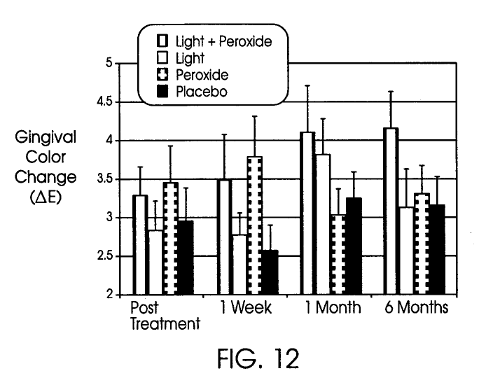

Gingival Papilla Color: The overall change in gingival color is depicted in FIG. 12. FIG. 12 illustrates that the treatment of light plus peroxide produces a significantly greater color change than any of the other treatments.

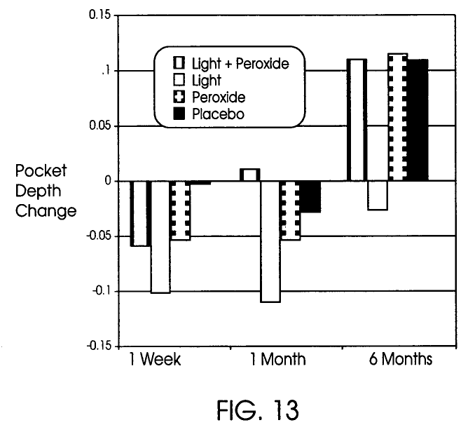

Probe Measurements (Pocket Depth, Attachment Level, and Bleeding on Probing): As depicted in FIG. 13, the pocket depth of each group exhibited a transient reduction after treatment. All treatments, except the control, yielded the benefit of pocket depth reduction at one week. The largest pocket depth reduction occurred with the light only treatment and is greatest at one week and one month. However, by six months all the groups return to baseline levels or greater.

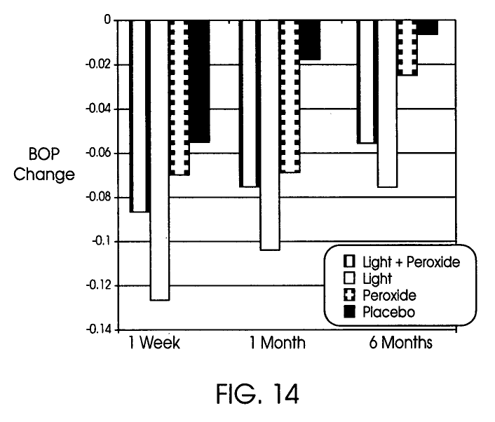

As depicted in FIG. 14, bleeding on probing reduced in all groups after treatment. Bleeding on probing (BOP) was the lowest, at all visits, in subjects treated with light plus peroxide. However, the greatest decrease in bleeding on probing occurred in the sites that received some form of light treatment.

PocketH₂S. Less than 0.1% of the samples contained H₂S.

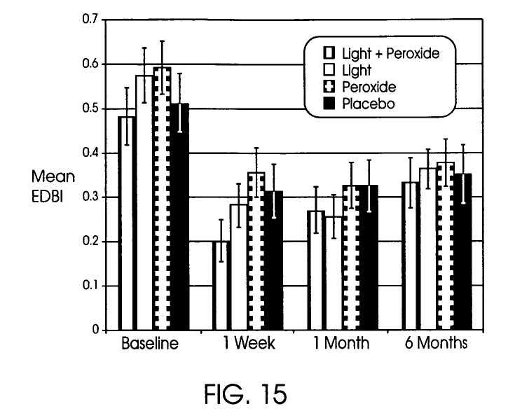

EDBI: As depicted in FIG. 15, EDBI is reduced in all groups after treatment. However, EDBI is the lowest, at all visits, in subjects treated with light plus peroxide.

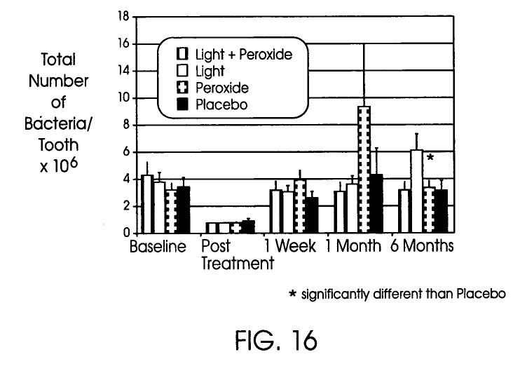

Data Evaluation: As shown in FIG. 16, the total number of bacteria on a tooth's surfaces decreases in all treatment groups. Specifically, a statistically significant change in the total bacterial numbers is seen in the light-only group at six months.

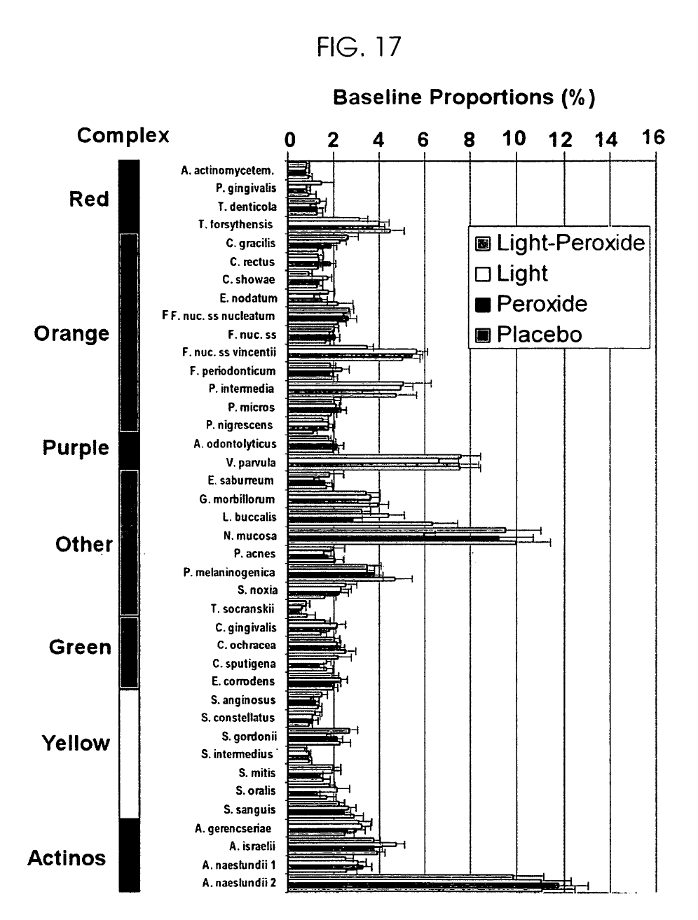

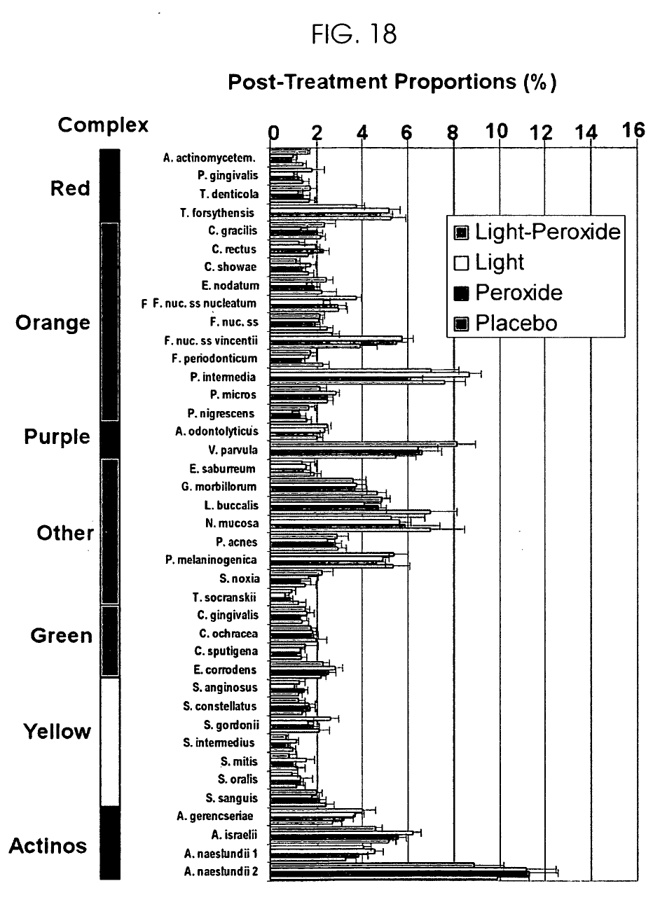

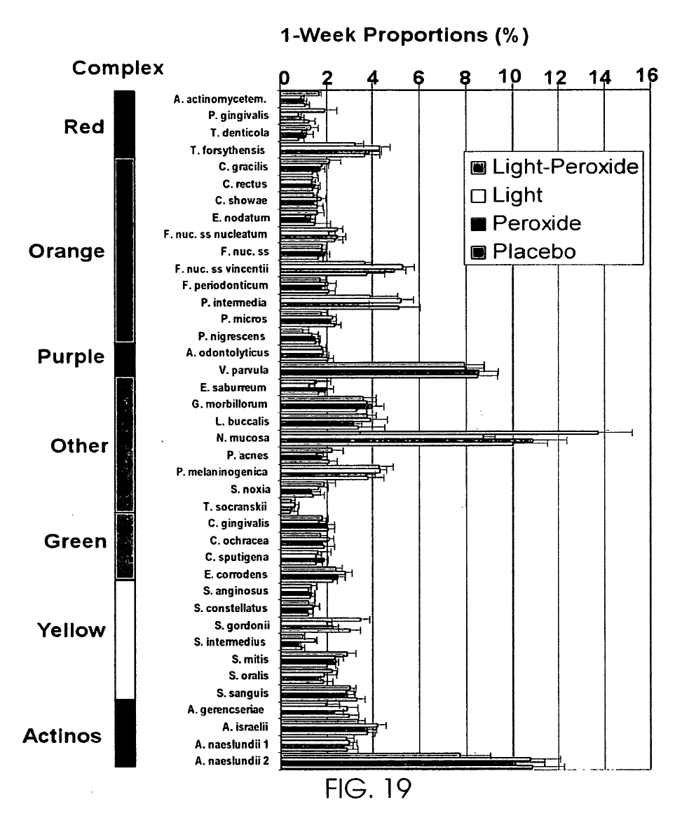

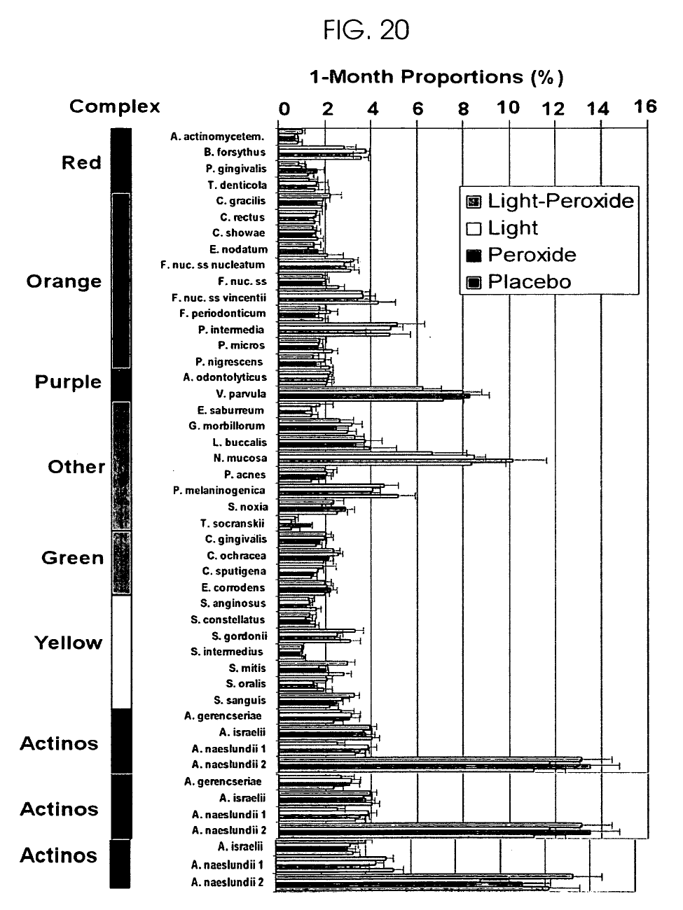

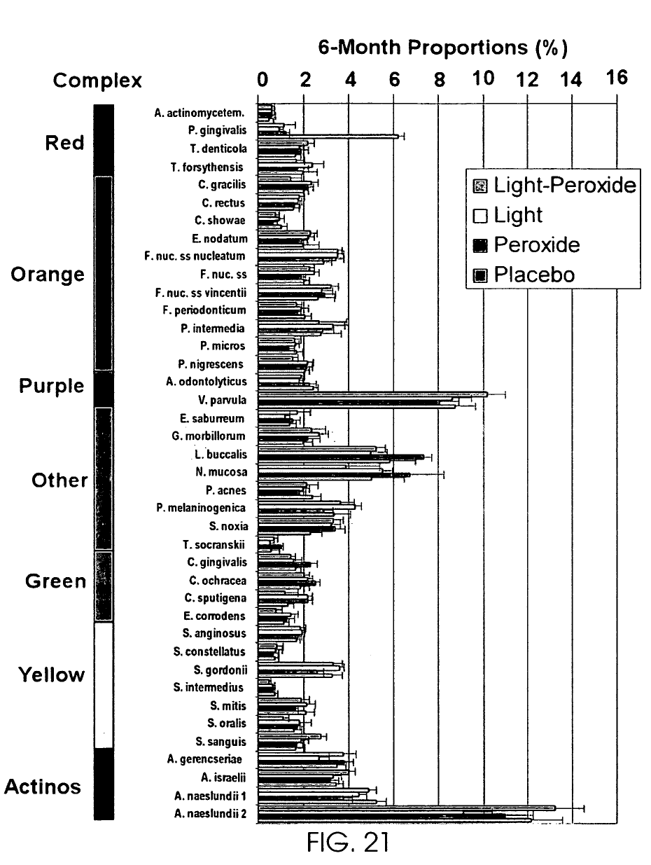

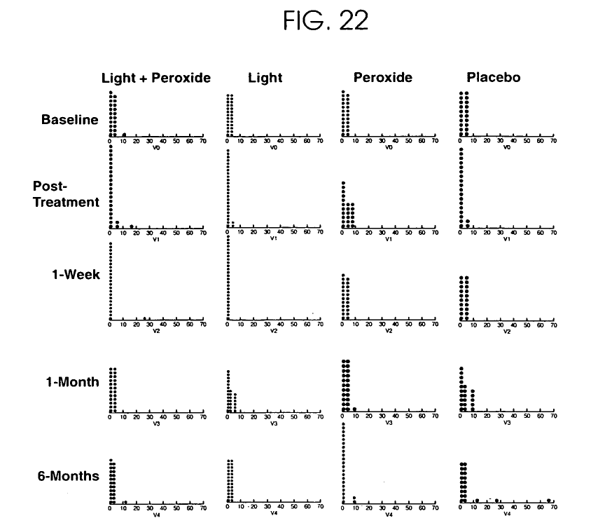

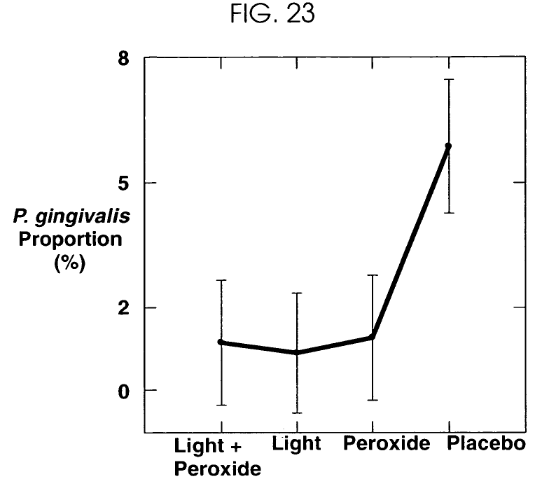

Numerous changes in the microbial population are also seen following the various treatments and the various time periods. FIGS. 17 through 21 illustrate the change in microbial proportions of the bacteria tested in each of the treatment groups and each of the time periods. In FIGS. 17 through 21, bacteria are grouped into seven complexes. The characteristics of these complexes are as follows. The first complex is the “red” complex, which includes all of the putative periodontal pathogens. The second complex is the “orange” complex, which contains bacteria associated with developing periodontitis. The third complex is the “purple” complex, which is largely associated with gingivitis. The fourth complex, termed the “other” complex, contains a group of bacteria recently added to the panel whose significance is uncertain. The fifth complex is the “green” complex, whose role, while largely unknown, is often associated with oral pathology including cancer. The sixth complex is the “yellow” complex, which contains all streptococci and is probably beneficial. The seventh complex is the “Actinomycetes” complex, which is numerically the largest component of periodontal plague and considered to be beneficial.

In the detailed study, P. gingivalis, exhibited noticeable changes upon treatment. FIG. 22 illustrates that the treatments of light plus peroxide and light only substantially reduced the proportions of P. gingivalis at one week, whereas the peroxide and control treatments were less effective. However, FIG. 23 shows that with the treatment of light plus peroxide, light only, or peroxide only, the mean P. gingivalis proportions in periodontal plaque was maintained below 2% over the six-month period. In contrast, P. gingivalis more than doubles in the control treated subjects (5%) over the same time period. Thus, light and/or peroxide exhibits the ability to maintain low proportions of P. gingivalis.

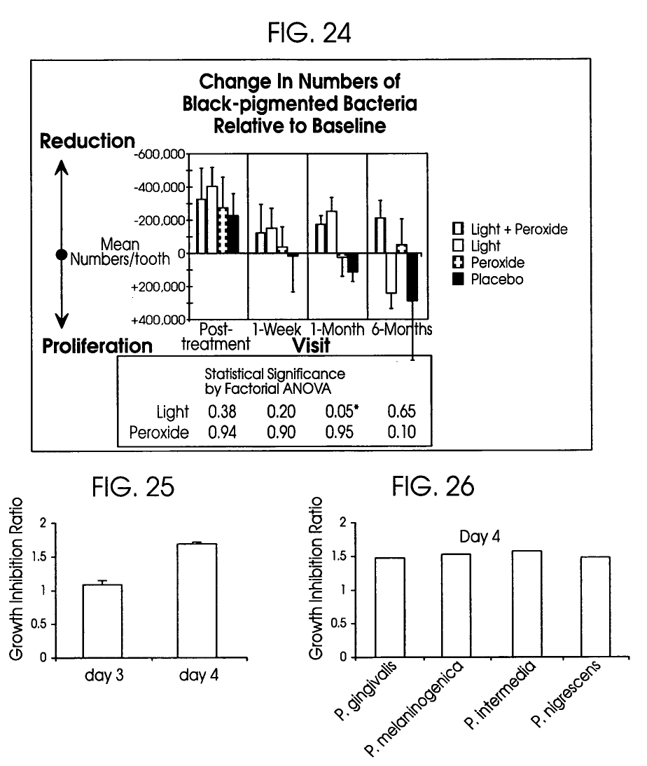

In an analysis of a data subset that represented only subjects with advanced gingivitis, the association between light exposure and reduction in black-pigmented species is more clearly seen (FIG. 24). In this instance, the ability of light to reduce the mean numbers of black-pigmented bacteria appears to be statistically significant (p=0.05) one month following exposure by factorial ANOVA.

Discussion

The data suggests that exposure to a light source and/or peroxide reduces the number of bacteria on the tooth surface and changes its bacterial composition. One example studied in detail was the change in proportions of P. gingivalis over the course of six months. Out of the four treatment groups, only treatment with light and/or peroxide reduced the proportions of P. gingivalis in periodontal plaque. In fact, the control group, irrespective of its increase in home care effectiveness, experienced a proliferation of this periodontal pathogen. Consequently, the data implies that exposure to a light source and/or peroxide is an effective way of reducing the number of bacteria on a tooth's surfaces.

In addition, the investigation of the effect of each therapy by a factorial analysis suggests that light alone decreased the proportion of P. gingivalis and that the effect was most prominent one month after treatment.

Similarly, the reduction of the Gingival Index by light suggests an additional benefit of the tooth whitening procedure. Further, the results suggest that subjects, who are exposed to a light source and/or peroxide, will be motivated to achieve higher levels of oral hygiene through intensified home care. This is illustrated by the fact that the control group experienced a 50% reduction of its Gingival Index. Moreover, the Plaque Index, a measure of home care, was reduced by approximately one-half of the baseline in all groups to the same degree and maintained at a low level throughout the study. The EDBI was reduced to the same extent by both the light and/or peroxide and the control treatments. These observations suggest that exposure to a light source and/or peroxide is a powerful stimulus to improve home care and gingival health.

The subset analysis of subjects with the highest degree of baseline inflammation reveals that significant effects on reduction of black-pigmented bacteria that are specific to light exposure can be measured in plaque taken from the mouths of patients up to one month following exposure. These in vivo observations clearly support the laboratory data that indicates that light exposure results in a reduction of black-pigmented species on the teeth adjacent to the gum tissue.

### Example 5

The purpose of this study was to investigate the effect of light exposure on biofilms made from periodontal plaque samples obtained from an individual with advanced periodontal disease.

Experimental Design

Multi-species biofilms were grown from dental plaque that was obtained from a patient with chronic destructive periodontitis. Biofilms were divided in 8 groups (4 biofilms per group).

These biofilms were irradiated with light of 455 nm for the times and exposures described in the following Table 4.

TABLE 4
POWER DENSITY: 50 mW/cm² EXPOSURE
TIME: 20 sec ENERGY FLUENCE: 1 J/cm²

| | Day 1 | Day 2 | Day 3 | Day 4 | TOTAL |
|---|---|---|---|---|---|
| Biofilm 1 | 1 Joule | — | — | — | |
| Control 1 | No light | — | — | — | 0 Joule |
| Biofilm 2 | 1 Joule | 1 Joule | — | — | 2 Joule |
| Control 2 | No light | No light | — | — | 0 Joule |
| Biofilm 3 | 1 Joule | 1 Joule | 1 Joule | — | 3 Joule |
| Control 3 | No light | No light | No light | — | 0 Joule |
| Biofilm 4 | 1 Joule | 1 Joule | 1 Joule | 1 Joule | 4 Joule |
| Control 4 | No light | No light | No light | No light | 0 Joule |

Results

Observations made over the first two days did not exhibit any reduction in the number of black-pigmented species. As indicated in the bars in FIG. 25, the growth inhibition ratio (total BPB in control biofilms/total BPB in treated biofilms) were 1.08±0.05 at day 3. This represents no difference between irradiated and non-irradiated biofilms. By day 4, however, the growth inhibition ratio was 1.66±0.02 indicating a clear reduction in bacterial growth in these periodontitis-derived biofilms. Detailed analysis of individual black-pigmented species indicated comparable inhibition in the range of 1.62 to 1.72 as depicted in FIG. 26.

Discussion

These observations suggest that in some cases, particularly those involving advanced periodontitis, it may be necessary to irradiate bacterial plaques repeatedly in order to obtain the desired effect.

### Example 6

The purpose of this study was to examine the change in composition of dental plaque bacteria resulting from intraoral light exposure.

Experimental Design

The buccal surfaces of the maxillary and mandibular premolars and molars of 11 subjects were exposed to a high-intensity (70 mW/cm²), intraoral light source, as depicted in FIGS. 1-4, with a typical wavelength of about 460 nm. The subjects were exposed to the intraoral light source twice daily for two-minute intervals, over a period of 4 days (Monday through Thursday). Each individual was exposed on the same randomly selected side 8 times prior to the final sampling. Consequently, each subject was exposed to the intraoral light for a total exposure of 16 minutes. To maintain cleanliness throughout the study, the intraoral light was covered by a disposable, clear, polyethylene film before each subject's use. The polyethylene film was found to produce a negligible attenuation of the light.

At each visit, the oral mucosa of each subject was examined by a hygienist responsible for conducting the study. In addition, each subject was asked to respond to a questionnaire concerning their perception of any problems that might have been associated with the procedures being conducted. Eight of the 11 subjects brushed their teeth regularly. Three of the subjects suspended all oral hygiene for the duration of the study.

Bacterial samples from each subject were taken at the start of the study period (Monday), and again at the end of the study period (Friday). The bacterial samples were acquired by harvesting the entire mass of bacterial plaque across the buccal surface of the maxillary and mandibular premolars and molars on both the side exposed to the high intensity light source (“exposed”) and the contralateral unexposed side (“unexposed”).

The bacterial composition of plaque samples was determined by a DNA probe analysis. The standard battery of 40 periodontal bacteria, as previously provided in Table 1, were included in the probe battery. The primary comparison in the study was the proportion of each bacterium from the exposed region, compared to the proportion of the same bacterium in the unexposed region.

Screening and Selection of the Subjects

Eleven subjects, 6 male and 5 female, were enrolled in this study. The subjects had an average age of 36 years (with age ranging from 21 to 65 years). The ethnic characteristics were principally Caucasian (63%) and Asian (27%). Only one subject smoked, and 82% of the subjects were right-handed. The average pocket depth of the subjects was 2.75±0.74 mm (mean±S.D., range 1.5-4.5 mm). At baseline, approximately 32% of sites bled on probing, 56% had visible plaque, and 46% were visibly red.

Results

The entire experiment was started and completed in 5 days. The study proceeded without incident. No evidence of intraoral irritation, pain, or discomfort associated with the procedure was observed. No subjects responded adversely to the questionnaire. Bacterial samples were promptly collected and analyzed.

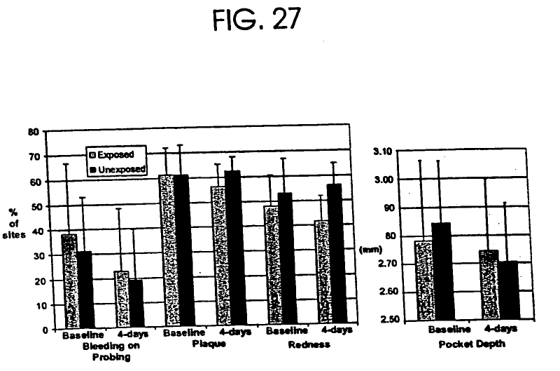

As illustrated by FIG. 27, the analysis of the bacterial samples showed that although the clinical measurements did change over the 4-day treatment period, the changes were not statistically significant. Bleeding on probing decreased on both the exposed and the unexposed sides. Plaque was slightly reduced on the exposed side relative to the unexposed side. The largest difference appeared in the characterization of redness between the two sides. The exposed side decreased by 6.2%, while the unexposed side increased by 3.3%.

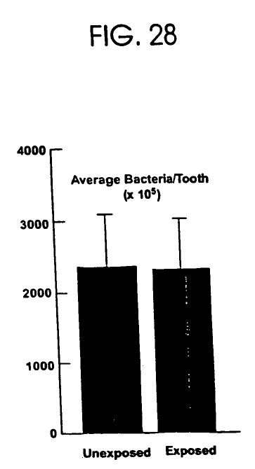

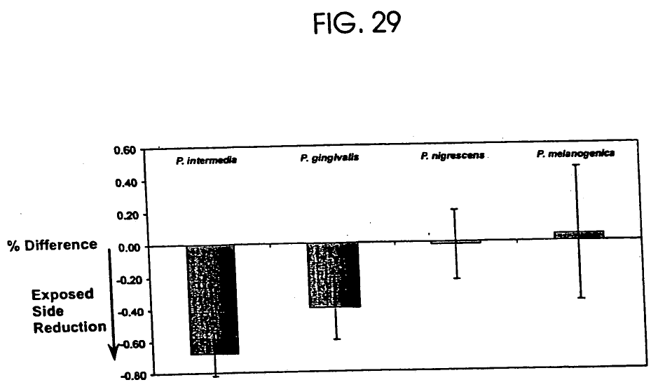

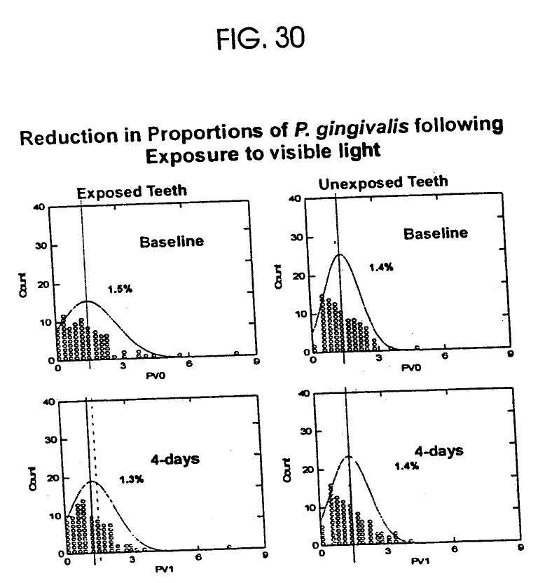

As depicted in FIG. 28, the average number of all types of bacteria on the exposed side, versus the average number of all types of bacteria on the unexposed side, did not statistically differ at the end of the study. However, FIG. 29 shows that there was some statistically significant changes in the types of black-pigmented bacteria between the exposed side and the unexposed side at the end of the study. Specifically, statistically significant changes were seen in the distribution of P. gingivalis and P. intermedia on the two sides, as represented in FIGS. 30-33.

Discussion

The above data indicates that of all the bacteria tested, only P. gingivalis and P. intermedia exhibited convincingly strong associations in both the comparative percent change and the treated side change.

As illustrated in FIG. 30, the distribution of P. gingivalis on the teeth at baseline and 4 days is sharper than the distribution at baseline on the exposed side. This suggests that high levels of P. gingivalis have been reduced by the exposure to light, but the change is obscured by large numbers with low levels of P. gingivalis at baseline, which did not have sufficient dynamic range to change.

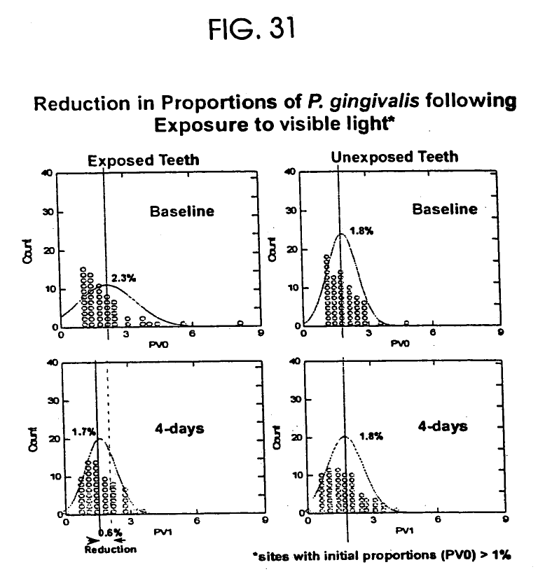

In addition, inspection of the change in the width of the distribution function on the exposed side between baseline and 4 days suggests that sites with higher proportions of P. gingivalis were reduced by the exposure to light, even though the differences were not statistically significant. Restricting consideration to those teeth with high initial levels of P. gingivalis (i.e., >1% at baseline) results in a statistically significant difference in the proportions of P. gingivalis at baseline and after 4 days of exposure. This distribution is illustrated in FIG. 31, which reveals that statistically significant differences were observed in association with the exposure to light.

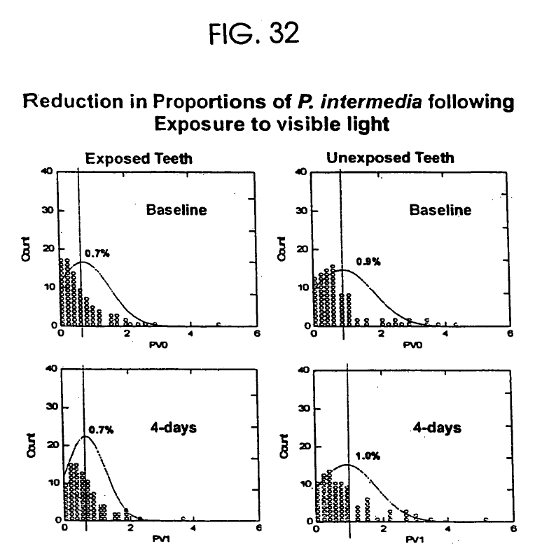

As depicted in FIG. 32, the distribution of P. intermedia on the teeth at baseline and 4 days is sharper than the distribution at baseline on the exposed side. This suggests that high levels of P. intermedia have been reduced by the exposure to light, but the change is obscured by large numbers with low levels of P. intermedia at baseline, which did not have sufficient dynamic range to change.

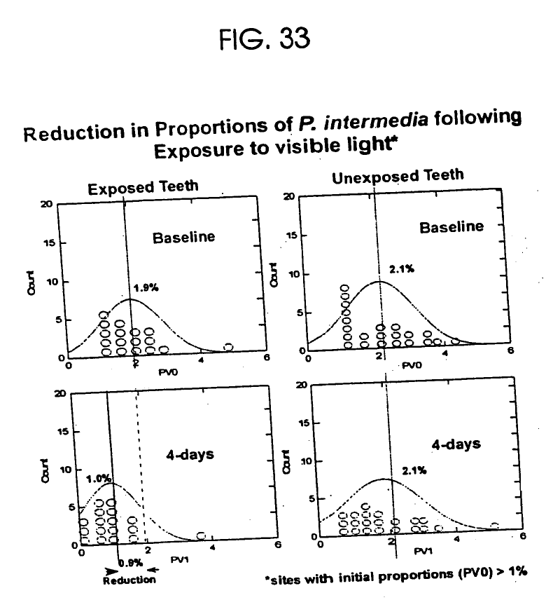

Furthermore, as noted in the case of P. gingivalis, inspection of the change in the width of the distribution function on the exposed side between baseline and 4 days suggests that the teeth with higher proportions were reduced by the exposure even though the differences were not statistically significant. Restricting consideration to those teeth with high initial levels of P. intermedia (i.e., >1% at baseline) also produced a statistically significant difference in the proportions at baseline and after 4 days of exposure. This distribution is illustrated in FIG. 33, which reveals that statistically significant differences were observed in association with the exposure to light.

Several bacteria were reduced in association to light exposure by levels comparable to those seen with P. gingivalis and P. intermedia, but the reduction did not achieve statistical significance. These included three fusobacteria (F. nuc. polymorph., F. periodonticum, and F. nuc. vincentii), one streptococcus (S. intermedius), and one capnocytophaga species (C. sputigena). F. nuc. polymorph. and F. periodonticum were reduced on the light-exposed side and proliferated on the unexposed side. The proportions of F. nuc. vincentii and S. intermedius were also reduced on both exposed and unexposed sides with the greater reduction being on the exposed side. The proportion of C. sputigena was unique in this group since the relative reduction was inhibition, but not reduction on the exposed side and proliferation on the unexposed side. It is possible that light effects may be exhibited by these species when larger studies are conducted.

Several bacteria appeared to change on both the exposed side and the unexposed side. These included A. naeslundii II, A. odontolyticus, P. acnes, A. israeli, T. socranskii, A. gerencseriae, and E. nodatum. Since substantial changes occurred on both sides of the mouth, this likely reflects changes related to oral hygiene or other subject level effects rather than light exposure.

P. micros was significantly reduced on the light exposed side, but failed to exhibit a significant comparative percent change. It is possible that the levels of P. micros were reduced by light exposure, but the degree of reduction being smaller than either P. gingivalis or P. intermedia was below the ability to be detected in the experimental design used.

When evaluating changes in percentage, when anything is reduced, something must increase as well. Of all the bacteria tested, however, only V. parvula appeared to increase and this change was not significantly associated with light exposure.

### Example 7

The purpose of this study, was to investigate the effect of broadband light (380-520 nm) on black-pigmented bacteria (“BPB”) in pure cultures as well as in dental plaque samples obtained from human subjects with chronic periodontitis.

Materials and Methods

Microorganisms: The pure bacterial strains used in this study were P. gingivalis (33277, ATCC), P. intermedia (25611, ATCC), P. nigrescens (33563, ATCC), P. melaninogenica (25845, ATCC) and S. constellatus (27823, ATCC). Cultures were maintained by weekly subculture in trypticase soy agar with 5 μg/ml hemin, 0.3 mg/ml vitamin K, and 5% sheep blood (manufactured plates from Northeast Labs, Waterville, Me.). Cultures were grown in the presence of 80% nitrogen, 10% hydrogen 10% carbon dioxide at 35° C. in an anaerobic chamber for 48-72 hours. On the day of the experiment, the cells were harvested by centrifugation and resuspended in brain heart infusion (“BHI”) broth (Becton Dickson and Company, Sparks, Md.). Cells were dispersed by sonication and repeated passage through Pasteur pipettes. For adjustment of inoculum density, cell numbers were estimated in a spectrophotometer (wavelength, 600 nm; 0.1 optical density unit equals approximately 108 cells/mL) in 1 mL cuvettes.

High-performance liquid chromatography (HPLC) analysis: For the extraction of total porphyrins from P. gingivalis, P. intermedia, P. nigrescens, and P. melaninogenica a two-phase extraction method was employed, which included the use of acidified ethyl acetate (ethyl acetate: glacial acetic acid/2:1) followed by 1M HCl. Iron-containing porphyrins (heme) was extracted into the organic solvent, but not extracted back into the acid phase. Thus, heme compounds were excluded. Porphyrins were quantified by scanning from 640 to 670 nm with an excitation wavelength at 400 nm using a Fluoromax-3 spectrofluorometer (Jobin Yvon, Edison, N.J.). The level of total porphyrins was calculated based on a reference porphyrin mixture standard. Porphyrins were fractionated by a reversed-phase HPLC method. The Waters HPLC system (Waters, Milford, Mass.) consisted of a 600 E system controller, 717 Autosampler, 470 fluorescence detector, 745B Data Module for peak integration. Separation of porphyrins was performed on a 150×3.9 mm Phenomenex C 18 Bondclone column (Phenomenex, Torrance, Calif.).

Subjects and plaque samples: Samples of subgingival plaque were taken from 15 patients. Permission to collect dental plaque samples was authorized by an IRB-approved informant consent. All patients were diagnosed as having chronic periodontitis with pockets greater than 3 mm in depth. None of them used antibiotics or had undergone periodontal treatment during the 3 months prior to sampling. Dental plaque samples were taken from the supra- and subgingival mesio-buccal aspects of premolars or molars in each patient with individual sterile Gracey curettes. The samples were placed immediately after their removal into an Eppendorf tube with 5 mL of pre-reduced anaerobically sterilized Ringer's solution. Cells were dispersed by sonication and repeated passage through Pasteur pipettes. Cell numbers were measured in a spectrophotometer in 1 mL tubes (one optical density unit equals approximately 109 cells/mL at 600 nm).

Light source: The irradiation source (BriteSmile model BS3000, BriteSmile, Inc., Walnut Creek, Calif.) consisted of two Mejiro metal halide gas plasma lamps with reflecting elements. The lamps are attached to two (one each) optical fiber bundles that lead to a “front end,” which breaks each bundle up into three rectangular emitting output areas. The spectral range of the light source was from 380 to 520 nm. A strong peak occurred at 435 nm and secondary peaks at 405, 420, 450 and 455 nm. The light source emitted 1.7% of the total energy in the ultraviolet range-A of the spectrum (380-400 nm).

Phototherapy studies—Bacterial cultures: Suspensions of bacteria (108/mL) were placed in the wells of 24-well plates. All four BPB as well as S. constellatus (non-black-pigmented control species) were exposed to light from the halogen lamp at room temperature from above with fluences ranging from 0 to 42 J/cm² at an irradiance of 70 mW/cm². The measured temperature rise in the medium was less than 3° C. during exposures to irradiation fluence of 42 J/cm². All plates were kept covered during the illumination in order to maintain the sterility of the culture. After illumination of the appropriate wells, serial dilutions of the contents of each well were prepared in BHI broth, and 100 mu1 aliquots were spread over the surfaces of enriched blood agar plates (enriched with vitamin K, N-acetyl muramic acid and hemin). The plates were incubated anaerobically at 35° C. for 7 days. Survival fractions in each well were calculated by counting the colony forming units (“CFU”) on the plates and dividing by the number of colonies from control plates that were not exposed to light and kept at room temperature for periods equal to irradiation times.

Phototherapy studies—Pooled dental plaque: Dispersed dental plaque (108/mL) were placed in the wells of 24-well plates and exposed to light with fluences of 4.2 J/cm² and 21 J/cm² at an irradiance of 70 mW/cm². After illumination, survival was estimated using two methods; by counting CFU as described above followed by total DNA-probe counts of 40 bacterial species using checkerboard DNA-DNA hybridization. For DNA-probe analysis, TE buffer (1.5 mL) was added to the plates and the bacterial colonies were scraped off the surface using sterile L-shaped glass rods. The suspensions were placed into individual Eppendorf tubes and sonicated for 10 seconds to break up clumps. The optical density (“OD”) of each suspension was adjusted to a final OD of 1.0, which corresponded to approximately 109 cells. Ten (10) μl of the suspension (107 cells) were removed and placed in another Eppendorf tube with 140 μl of TE buffer and 150 μl of 0.5M NaOH. The samples were lysed and the DNA was placed in lanes on positively charged nylon membrane using a Minislot device (Immunetics, Cambridge, Mass., USA). After fixation of the DNA to the membrane, the membrane was placed in Miniblotter 45 (Immunetics) with the lanes of DNA at perpendicular to the lanes of the device. Digoxigenin-labeled whole genomic DNA probes to 40 bacteria taxa were hybridized in individual lanes of the Miniblotter. After hybridization, the membranes were washed at high stringency and the DNA probes were detected using antibody to digoxigenin conjugated with alkaline phosphatase for chemifluorescence detection. Signals were detected using AttoPhos substrate (Amersham Life Science, Arlington Heights, Ill., USA) and were scanned using a Storm Fluorimager (Molecular Dynamics, Sunnyvale, Calif., USA). Computer-generated images were analyzed to determine the fluorescence intensity associated with each sample and probe. Two lanes in each membrane contained DNA standards with 1 ng (105 bacteria) and 10 ng (106 bacteria) of each species. The sensitivity of the assay was adjusted to permit detection of 104 cells of a given species by adjusting the concentration of each DNA probe. The measured fluorescence intensities were converted to absolute counts by comparison with the standards on the same membrane. Failure to detect a signal was recorded as zero. The growth inhibition of BPB was defined as the ratio of DNA probe counts before and after exposure to light. Differences between mean values of growth inhibition ratios or percentages were tested for statistical significance using Student's t test.

Results

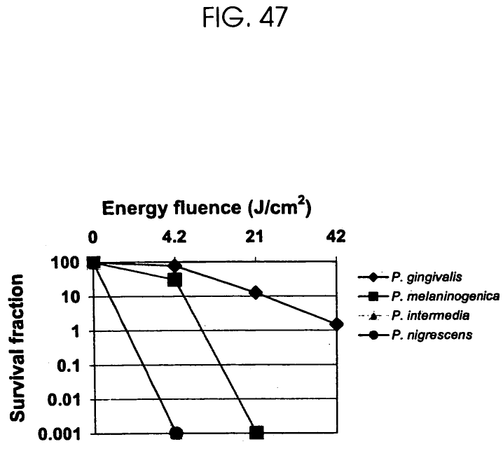

Photodestruction of bacterial cultures: The effects of increasing light doses from the light source on cultures of BPB are shown in FIG. 47. P. intermedia and P. nigrescens were completely killed by exposure to light with fluence of 4.2 J/cm² (1 minute irradiation). P. melaninogenica was reduced by 70% with 4.2 J/cm² (P<0.008) and was completely killed by exposure to 21 J/cm² (5 minutes irradiation). The survival fraction of P. gingivalis was 77.25% (P<0.001), 12.55% (P<0.00002) and 1.48% (P<0.000001) after exposure to light with fluences of 4.2, 21 and 42 J/cm² respectively. S. constellatus, a non-pigmented species, was unaffected by irradiation (data not shown in FIG. 47).

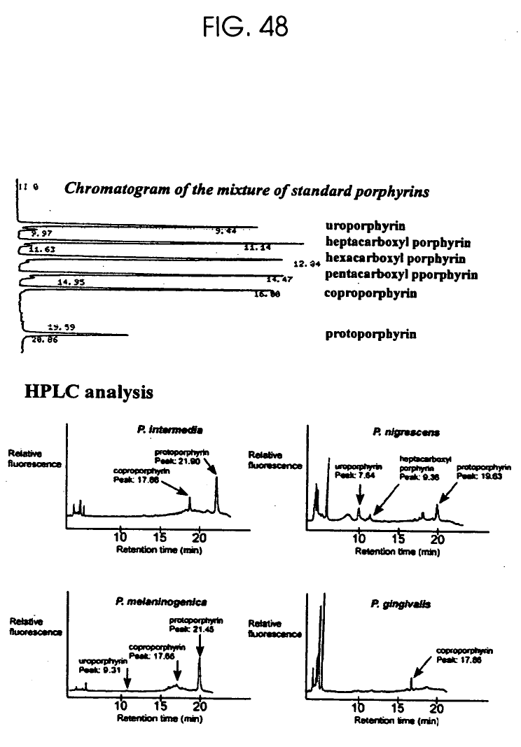

HPLC analysis: HPLC revealed that BPB expressed different porphyrins patterns (FIG. 48). The percent porphyrin content in BPB is shown in FIG. 48. The amount of porphyrin was 267, 47, 41 and 2.2 ng per mg protein in P. intermedia, P. nigrescens, P. melaninogenica and P. gingivalis respectively. The large signals appearing at the solvent front in the chromatograms of P. nigrescens and P. gingivalis represent low molecular weight fluorescent compounds of bacterial origin (FIG. 48).

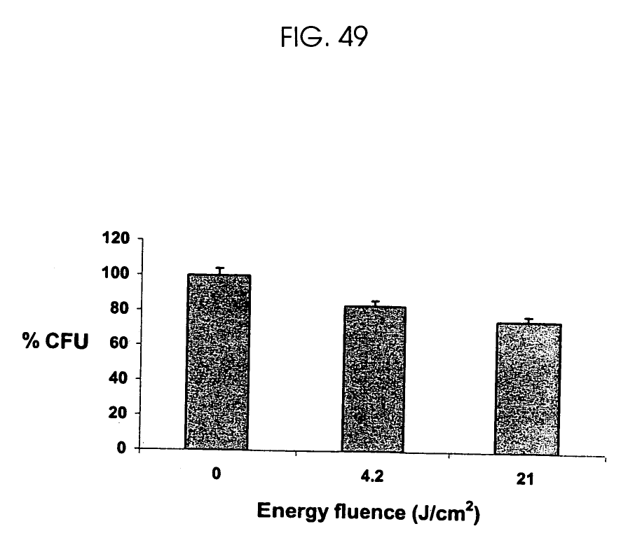

Phototherapy of dental plaque microorganisms—CFU: FIG. 49 shows the reduction of total CFU after exposure of dental plaque samples to light with energy fluence of 4.2 J/cm² and 21 J/cm². The survival fractions were reduced by 17% (P<0.00002) and 25% respectively (P<0.0000007).

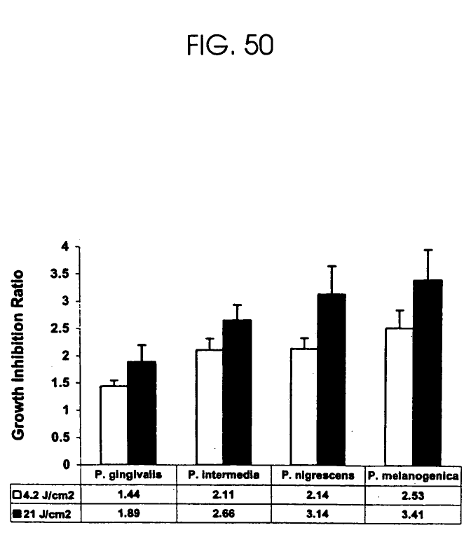

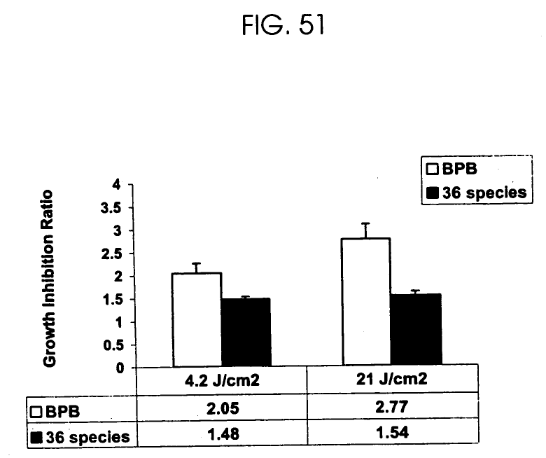

Phototherapy of dental plaque microorganisms—Checkerboard DNA-DNA hybridization: FIG. 50 shows the growth inhibition ratios of BPB after exposure of dental plaque samples to light with energy fluence of 4.2 j/cm² and 21 J/cm². The order of growth inhibition ranked P. melaninogenica>P. nigrescens>P. intermedia>P. gingivalis for both energy fluencies. The growth inhibition ratios of all BPB were statistically significant at both energy fluences compared with those of controls (P<0.05). On the other hand, the growth inhibition ratios of BPB at 21 j/cm² were not statistically significant compared with those at 4.2 J/cm² (P>0.05) with the exception of P. intermedia (P<0.02). The growth of all 4 BPB was suppressed 2 and 2.8 times at the energy fluences of 4.2 J/cm² and 21 j/cm² respectively (P<0.05) whereas the remaining 36 microorganisms were inhibited 1.5 times at both energy fluences, as depicted in FIG. 51.

Discussion

These data suggest that visible light could be used prophylactically to stabilize the normal microbial composition of the plaque by suppressing the potentially pathogenic BPB. Compared with other forms of periodontal therapy (scaling, mouthwashes, surgery), this form of treatment would offer many advantages; it is painless, rapid, devoid of drug toxicity, has no effect on taste and is selective in its effect.

### Example 8

Experimental Design

Subjects were enrolled from two previously-completed Forsyth whitening studies. The subjects were (1) a subset of patients from the BriteSmile, Inc. “light plus gel” leg of the Forsyth Safety and Efficacy study and (2) a subset of patients from the BriteSmile, Inc. leg of the Forsyth Comparison study. All of the subjects received the standard BriteSmile, Inc. tooth whitening treatment. Subjects were measured at baseline, immediately post treatment and at 3, 6, 12, 18, and 24 months during and after each of the two studies. Since not all subjects cooperated with the follow-up study, the dataset has some gaps. Of the subjects who agreed to follow-up measurements, each participant was monitored over a 2-year period to evaluate the degree of regression, if any. The last subject was seen on Dec. 21, 2002.

Gingival Index

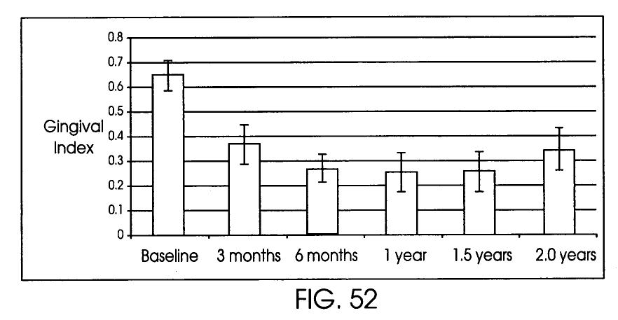

One of the most surprising findings of this study is that the reduction in gingival index that followed whitening application persisted throughout the 2-year monitoring period (FIG. 52). This finding has been observed repeatedly in three Forsyth whitening studies. In fact, the reduction in Gingival Index that occurs following a BriteSmile, Inc. treatment lasts for at least two years. This would suggest that a permanent microbiological change may occur in the mouths of those treated.

Plaque Index

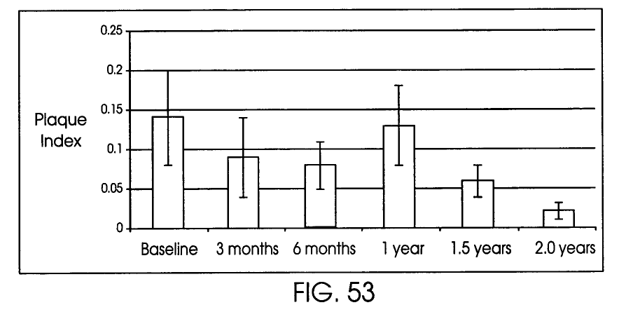

At least part of the BriteSmile, Inc. effect on Gingival Index may be explained by a reduction in Plaque Index (FIG. 53). By its nature, evaluation of Plaque Index tends to be variable. In this study, a continual reduction in Plaque Index over the 2-year period was observed. Specifically, at the end of the 2-year observation period, the changes in Plaque Index values relative to baseline approached statistical significance.

Conclusions

A single BriteSmile, Inc. treatment can increase tooth whiteness and decrease gingival redness. Some of the therapeutic effect can remain up to two years after initial application.

A number of embodiments of the invention have been described. Nevertheless, it will be understood that various modifications may be made without departing from the spirit and scope of the invention. Accordingly, other embodiments are within the scope of the following claims, and as various changes can be made to the above compositions, formulations, combinations, and methods without departing from the scope of the invention, it is intended that all matter contained in the above description be interpreted as illustrative and not in a limiting sense. All patent documents and references listed herein are incorporated by reference in their entireties.

1. A device useful for improving oral health, comprising:
a light source located within a handle;
a light distributor having a distal end and a proximal end in communication with the light source; and
a bitewing removably attached to the distal end of the light distributor;
wherein the light source is configured to remain outside of the oral cavity during use and the light distributor is configured to be placed inside the oral cavity during use.

2. The device of claim 1, wherein the light source comprises at least one emitter.

3. The device of claim 2, wherein the light source further comprises a heat sink.

4. The device of claim 1, wherein the light source is a light-emitting diode.

5. The device of claim 1, wherein the light distributor comprises any suitable transmitting material with a high index of refraction.

6. The device of claim 5, wherein the light distributor comprises a polycarbonate.

7. The device of claim 6, wherein the light distributor comprises polymethyl methylacrylate.

8. The device of claim 1, wherein the light distributor comprises at least one light pipe.

9. The device of claim 8, wherein the light distributor comprises two light pipes.

10. The device of claim 8, wherein the distal end of the at least one light pipe comprises at least one facet.

11. The device of claim 1, further comprising a connector configured to connect the light source to the proximal end of the light distributor.

12. The device of claim 1, further comprising a collimator engaged to the proximal end of the light distributor.

13. The device of claim 12, wherein the collimator is removably engaged to the proximal end of the light distributor.

14. The device of claim 12, wherein the collimator is integrated with the light distributor.

15. The device of claim 12, further comprising a socket, wherein the proximal end of the light distributor engages the socket, which connects to the collimator.

16. The device of claim 1, wherein the light distributor comprises at least one light guide.

17. The device of claim 16, wherein the light guide comprises a hollow tube.

18. The device of claim 17, wherein the hollow tube comprises a thin wall.

19. The device of claim 18, wherein the thin wall comprises a highly polished, reflective material.

20. The device of claim 16, further comprising a mirror located inside the light guide near the distal end.

21. The device of claim 20, further comprising a transparent window located at the distal end of the light guide.

22. The device of claim 1, wherein the light source is configured to emit a therapeutically effective amount of light in the wavelength range of from about 350 nm to about 700 nm.

23. The device of claim 1, wherein the light source is configured to emit a therapeutically effective amount of light in the wavelength range of from about 380 nm to about 520 nm.

24. The device of claim 1, wherein the light source is configured to emit a therapeutically effective amount of light in the wavelength range of from about 400 nm to about 505 nm.

25. The device of claim 1, wherein the light source is configured to emit a therapeutically effective amount of light in the wavelength range of from about 430 nm to about 510 mm.

26. The device of claim 1, wherein the device is free of bristles.

27. The device of claim 1, further comprising a massaging means.

28. The device of claim 1, further comprising a vibrating means.

29. The device of claim 1, wherein the device is battery operated.

30. The device of claim 1, further comprising an external power source.

31. The device of claim 1, further comprising a rechargeable power source.

32. The device of claim 1, wherein the at least one light distributor is replaceable.

33. A method for improving the oral health of a subject comprising:
administering a therapeutically effective amount of light to an oral cavity of the subject delivered from the device of claim 1.

34. The method of claim 33, wherein the therapeutically effective amount of light is administered in a predetermined dosage.

35. The method of claim 34, wherein the predetermined dosage is administered in the range of from about 0.1 Joules/cm² to about 1000 Joules/cm².

36. The method of claim 34, wherein the predetermined dosage is administered in the range of from about 0.1 Joules/cm² to about 500 Joules/cm².

37. The method of claim 34, wherein the predetermined dosage is administered in the range of from about 0.1 Joules/cm² to about 100 Joules/cm².

38. The method of claim 34, wherein the predetermined dosage is administered in the range of from about 0.1 Joules/cm² to about 50 Joules/cm².

39. The method of claim 34, wherein the predetermined dosage is administered in the range of from about 0.1 Joules/cm² to about 10 Joules/cm².

40. The method of claim 33, wherein the therapeutically effective amount of light comprises one or more predetermined wavelengths.

41. The method of claim 40, wherein the predetermined wavelength of light is in the range of from about 350 nm to about 700 nm.

42. The method of claim 40, wherein the predetermined wavelength of light is in the range of from about 380 nm to about 520 nm.

43. The method of claim 40, wherein the predetermined wavelength of light is in the range of from about 400 nm to about 505 nm.

44. The method of claim 40, wherein the predetermined wavelength of light is in the range of from about 430 nm to about 510 nm.

45. The method of claim 40, wherein the predetermined wavelength of light comprises one or more distinct wavelength regions in the range of from about 350 nm to about 700 nm.

46. The method of claim 33, wherein the therapeutically effective amount of light is administered to the oral cavity of the subject one time per day.

47. The method of claim 33, wherein the therapeutically effective amount of light is administered to the oral cavity of the subject more than one time per day.

48. The method of claim 33, wherein the therapeutically effective amount of light is administered to the oral cavity of the subject two times per day.

49. The method of claim 33, wherein the therapeutically effective amount of light is administered to the oral cavity of the subject three times per day.

50. The method of claim 33, wherein the therapeutically effective amount of light is administered to the oral cavity of the subject for a predetermined length for at least one time per day.

51. The method of claim 50, wherein the predetermined length is at least 5 seconds.

52. The method of claim 50, wherein the predetermined length is in the range of from about 5 seconds to about 1 minute.

53. The method of claim 50, wherein the predetermined length is in the range of from about 5 seconds to about 2 minutes.

54. The method of claim 50, wherein the predetermined length is in the range of from about 5 seconds to about 5 minutes.

55. The method of claim 50, wherein the predetermined length is in the range of from about 5 seconds to about 15 minutes.

56. The method of claim 33, wherein the therapeutically effective amount of light is administered by a pulsed effect.

57. The method of claim 33, wherein the therapeutically effective amount of light is administered for a predetermined period of time.

58. The method of claim 58, wherein the period is in the range of from about two weeks to about one month.

59. The method of claim 58, wherein the period is in the range of from about two weeks to about six months.

60. The method of claim 58, wherein the period is in the range of from about two weeks to about nine months.

61. The method of claim 58, wherein the period is in the range of from about two weeks to about one year.

62. The method of claim 33, wherein the therapeutically effective amount of light has an anti-inflammatory effect.

63. The method of claim 33, wherein the therapeutically effective amount of light has an anti-bacterial effect.

64. The method of claim 33, wherein the therapeutically effective amount of light has a sterilizing effect.

65. The method of claim 33, wherein the therapeutically effective amount of light has a pain-relieving effect.

66. The method of claim 33, wherein the therapeutically effective amount of light has an increased immune response effect.

67. The method of claim 33, wherein the therapeutically effective amount of light has a periodontal improvement effect.

68. The method of claim 33, wherein a therapeutically effective amount of an oxidizing agent is administered to the oral cavity of the subject prior to administering the therapeutically effective amount of light to the oral cavity of the subject.

69. The method of claim 33, wherein a therapeutically effective amount of a cleaning agent is administered to the oral cavity of the subject prior to administering the therapeutically effective amount of light to the oral cavity of the subject.

70. The method of claim 33, wherein the oral cavity comprises the entire mouth.

71. The method of claim 33, wherein the oral cavity consists of the lingual surfaces of the teeth and gums.

72. The method of claim 33, wherein the oral cavity consists of the buccal surfaces of the teeth and gums.

73. The method of claim 33, wherein the oral cavity consists of the upper surface of the tongue.

74. The method of claim 33, wherein the therapeutically effective amount of light has an energy density of from about 1 mWatt/cm² to about 1000 mWatts/cm².

75. The method of claim 33, wherein the therapeutically effective amount of light has an energy density from about 1 mWatt/cm² to about 800 mWatts/cm².

76. The method of claim 33, wherein the therapeutically effective amount of light has an energy density from about 1 mWatt/cm² to about 200 mWatts/cm².

77. The method of claim 33, wherein the therapeutically effective amount of light has an energy density from about 1 mWatt/cm² to about 120 mWatts/cm².

78. The method of claim 33, wherein the therapeutically effective amount of light eliminates from about 5% to about 100% of bacteria present in the oral cavity.

79. The method of claim 33, wherein the therapeutically effective amount of light eliminates from about 5% to about 75% of bacteria present in the oral cavity.

80. The method of claim 33, wherein the therapeutically effective amount of light eliminates from about 5% to about 50% of bacteria present in the oral cavity.

81. The method of claim 33, wherein the therapeutically effective amount of light eliminates from about 5% to about 25% of bacteria present in the oral cavity.

82. The method of claim 33, wherein the therapeutically effective amount of light eliminates from about 5% to about 100% of the black-pigmented bacteria.

83. The method of claim 33, wherein the therapeutically effective amount of light eliminates from about 5% to about 75% of the black-pigmented bacteria.

84. The method of claim 33, wherein the therapeutically effective amount of light eliminates from about 5% to about 50% of the black-pigmented bacteria.

85. The method of claim 33, wherein the therapeutically effective amount of eliminates from about 5% to about 25% of the black-pigmented bacteria.

86. A device, comprising:
a light source located within a handle; and
at least one light pipe having a distal end comprising at least one facet and a proximal end;
wherein the proximal end of the light pipe is in communication with the light source.

87. The device of claim 86, wherein the at least one facet is configured to distribute light in a uniform pattern from the light pipe.

88. The device of claim 86, wherein the at least one facet comprises more than one facet.

89. The device of claim 86, wherein the at least one facet comprises seven facets.

90. The device of claim 88, wherein the more than one facet comprises at least one primary facet and at least one secondary facet.

91. The device of claim 90, wherein the at least one primary facet comprises four primary facets and the at least one secondary facet comprises three facets.

92. A device, comprising:
a light source located within a handle;
at least one light guide having a distal end comprising an opening and a proximal end in communication with the light source;
a transparent mirror located at the distal end of the at least one light guide and configured to cover the opening; and
a mirror located at the distal end of the at least one light guide.
